(19) United States
(12) Patent Application Publication
(10) Pub. No.: US 2019/0087344 A1
(43) Pub. Date: Mar. 21, 2019

(54) Reducing Clean Evictions In An Exclusive Cache Memory Hierarchy

(71) Applicant: QUALCOMM Incorporated, San Diego, CA (US)

(72) Inventor: Farrukh HIJAZ, San Diego, CA (US)

(21) Appl. No.: 15/709,960

(22) Filed: Sep. 20, 2017

(51) Int. Cl. G06F 12/0891; G06F 12/0811; G06F 12/084; G06F 12/0875

(52) U.S. Cl. CPC G06F 12/0891; G06F 12/0811; G06F 12/084; G06F 2212/62; G06F 2212/1021; G06F 2212/60; G06F 12/0875

(57) ABSTRACT

Various aspects include methods for implementing reducing clean evictions in an exclusive cache memory hierarchy on a computing device. Various aspects may include receiving a signal relating to a victim cache line candidate in a higher level cache memory that may include an accessed indicator of the victim cache line candidate or a demote message. A hit counter and/or an inclusion mode indicator of a victim cache line in a lower level cache memory that corresponds to the victim cache line candidate may be updated in response to receiving the signal. Updating the hit counter may depend on determining whether the accessed indicator is set, and may include increasing or decreasing the hit counter. Updating the inclusion mode indicator may depend on determining whether the accessed indicator is set and/or whether the hit counter exceeds an inclusion mode threshold, and may include setting or resetting the inclusion mode indicator.

### BACKGROUND

Exclusive cache hierarchy is generally preferred in most computing devices, specifically mobile systems on chip (SoCs), to maximize cache capacity. The lower level caches can either be exclusive or inclusive. Although providing higher caching capacity, a clean cache line evicted from a level 1 (L1) cache must be written back to a lower level cache memory. This leads to higher bandwidth and energy consumption in exclusive cache configurations. The problem is magnified at the shared last level cache, because frequent writes to the cache are more expensive and keeping bandwidth utilization low is preferred as multiple cores are accessing the last level cache.

### SUMMARY

Various disclosed aspects may include apparatuses and methods for reducing clean evictions in an exclusive cache memory hierarchy on a computing device. Various aspects may include receiving an accessed indicator of a victim cache line candidate in a higher level cache memory, updating a hit counter of a victim cache line in a lower level cache memory that corresponds to the victim cache line candidate in response to receiving the accessed indicator of the victim cache line candidate, determining whether the hit counter of the victim cache line exceeds an inclusion mode threshold, setting an inclusion mode indicator of the victim cache line in response to determining that the hit counter of the victim cache line exceeds the inclusion mode threshold, and resetting the inclusion mode indicator of the victim cache line in response to determining that the hit counter of the victim cache line does not exceed the inclusion mode threshold.

Some aspects may further include determining whether the accessed indicator of the victim cache line candidate is set, in which updating a hit counter of a victim cache line may include increasing the hit counter of the victim cache line in response to determining that the accessed indicator of the victim cache line candidate is set, and decreasing the hit counter of the victim cache line in response to determining that the accessed indicator of the victim cache line candidate is not set.

Some aspects may further include determining the victim cache line candidate in higher level cache memory, determining whether an inclusion mode indicator of the victim cache line candidate is set, determining whether a dirty indicator of the victim cache line candidate is set in response to determining that the inclusion mode indicator of the victim cache line candidate is set, and sending the accessed indicator of the victim cache line candidate to the lower level cache memory in response to determining that the dirty indicator of the victim cache line candidate is not set.

Some aspects may further include evicting the victim cache line candidate from the higher level cache memory in response to determining that the dirty indicator of the victim cache line candidate is set, sending all data of the victim cache line candidate to the lower level cache memory in response to determining that the dirty indicator of the victim cache line candidate is set, evicting the victim cache line candidate from the higher level cache memory in response to determining that the inclusion mode indicator of the victim cache line candidate is not set, and sending all the data of the victim cache line candidate to the lower level cache memory in response to determining that the inclusion mode indicator of the victim cache line candidate is not set.

Some aspects may further include receiving a first cache access request for a cache line in the higher level cache memory, determining whether the first cache access request is a hit for the cache line, and sending a second cache access request for the cache line to the lower level cache memory in response to determining that the first cache access request is not a hit for the cache line.

Some aspects may further include receiving the second cache access request for the lower level cache memory, returning the cache line from the lower level cache memory to the higher level cache memory, determining whether an inclusion mode indicator of the cache line in the lower level cache memory is set, maintaining the cache line in the lower level cache memory in response to determining that the inclusion mode indicator of the cache line in the lower level cache memory is set, and invalidating the cache line in the lower level cache memory in response to determining that the inclusion mode indicator of the cache line in the lower level cache memory is not set.

Some aspects may further include inserting the returned cache line into the higher level cache memory, setting an inclusion mode indicator of the returned cache line in response to determining that the inclusion mode indicator of the cache line in the lower level cache memory is set, and executing the first cache access request.

Some aspects may further include determining whether an accessed indicator of the cache line is set in response to determining that the first cache access request is a hit for the cache line, setting the accessed indicator of the cache line in response to determining that the accessed indicator of the cache line is not set, and executing the first cache access request.

Various aspects may include apparatuses and methods for reducing clean evictions in an exclusive cache memory hierarchy on a computing device. Various aspects may include receiving a signal relating to a victim cache line candidate in a higher level cache memory, and updating an inclusion mode indicator of a victim cache line in a lower level cache memory that corresponds to the victim cache line candidate in response to receiving the signal relating to the victim cache line candidate.

In some aspects, the signal relating to the victim cache line candidate may include an accessed indicator of the victim cache line candidate. Some aspects may further include determining whether the accessed indicator of the victim cache line candidate is set, in which updating an inclusion mode indicator of a victim cache line may include setting the inclusion mode indicator of the victim cache line in response to determining that the accessed indicator of the victim cache line candidate is set, and resetting the inclusion mode indicator of the victim cache line in response to determining that the accessed indicator of the victim cache line candidate is not set.

In some aspects, the signal relating to the victim cache line candidate may include a demote message from the higher level cache memory, and updating an inclusion mode indicator of a victim cache line may include resetting the inclusion mode indicator of the victim cache line in response to receiving the demote message.

Some aspects may further include determining the victim cache line candidate in higher level cache memory, determining whether an inclusion mode indicator of the victim cache line candidate is set, silently evicting the victim cache line candidate in response to determining that the inclusion mode indicator of the victim cache line candidate is set, determining whether an accessed indicator of the victim cache line candidate is set in response to determining that the inclusion mode indicator of the victim cache line candidate is set, and sending a demote message to the lower level cache memory in response to determining that the accessed indicator of the victim cache line candidate is not set.

Some aspects may further include receiving a first cache access request for a cache line in the higher level cache memory, determining whether the first cache access request is a hit for the cache line, and sending a second cache access request for the cache line to the lower level cache memory in response to determining that the first cache access request is not a hit for the cache line.

Some aspects may further include receiving the second cache access request for the lower level cache memory, determining whether the second cache access request is a hit for the cache line, returning the cache line from the lower level cache memory to the higher level cache memory in response to determining that the second cache access request is a hit for the cache line, determining whether an inclusion mode indicator of the cache line in the lower level cache memory is set, invalidating the cache line in the lower level cache memory in response to determining that the inclusion mode indicator of the cache line in the lower level cache memory is not set, determining whether the first cache access request includes a load instruction in response to determining that the inclusion mode indicator of the cache line in the lower level cache memory is set, maintaining the cache line in the lower level cache memory in response to determining that the first cache access request includes a load instruction, and invalidating the cache line in the lower level cache memory in response to determining that the first cache access request does not include a load instruction.

Some aspects may further include receiving the second cache access request for the lower level cache memory, determining whether the second cache access request is a hit for the cache line, retrieving the cache line from a memory in response to determining that the second cache access request is not a hit for the cache line, determining whether the first cache access request includes a load instruction, inserting the cache line into the lower level cache memory in response to the first cache access request includes a load instruction, setting an inclusion mode indicator for the cache line in the lower level cache memory, and returning the cache line to the higher level cache memory.

Some aspects may further include receiving a first cache access request for a cache line in the higher level cache memory, executing the first cache access request, determining whether a dirty indicator for the cache line is set, determining whether an inclusion mode indicator for the cache line is set in response to determining that the dirty indicator for the cache line is set, resetting the inclusion mode indicator for the cache line in response to determining that the inclusion mode indicator for the cache line is set, and sending an invalidation message for the cache line to the lower level cache memory in response to determining that the inclusion mode indicator for the cache line is set.

Various aspects include computing devices having a processor, a higher level cache memory, a lower level cache memory, and a cache memory manager configured to perform operations of any of the methods summarized above.

### BRIEF DESCRIPTION OF THE DRAWINGS

The accompanying drawings, which are incorporated herein and constitute part of this specification, illustrate example aspects of various aspects, and together with the general description given above and the detailed description given below, serve to explain the features of the claims.

FIG. 1 is a component block diagram illustrating a computing device suitable for implementing various aspects.

FIG. 2 is a component block diagram illustrating components of a computing device suitable for implementing various aspects.

FIGS. 3A-3K are block diagrams illustrating examples of reducing clean eviction in a cache memory hierarchy in a system configured to promote high locality data to an inclusive mode suitable for implementing various aspects.

FIG. 4 is a process flow diagram illustrating a method for reducing clean eviction in a cache memory hierarchy according to an aspect.

FIG. 5 is a process flow diagram illustrating a method for retrieving a cache line from a lower level cache memory for reducing clean eviction in a cache memory hierarchy according to an aspect.

FIG. 6 is a process flow diagram illustrating a method for finding a victim cache line candidate in a higher level cache memory for reducing clean eviction in a cache memory hierarchy according to an aspect.

FIG. 7 is a process flow diagram illustrating a method for updating a lower level cache memory for reducing clean eviction in a cache memory hierarchy according to an aspect.

FIG. 8 is a process flow diagram illustrating a method for updating a higher level cache memory for reducing clean eviction in a cache memory hierarchy according to an aspect.

FIGS. 9A-9H are block diagrams illustrating examples of reducing clean eviction in a cache memory hierarchy in a system configured to relax exclusivity requirements suitable for implementing various aspects.

FIG. 10 is a process flow diagram illustrating a method for retrieving a cache line from a lower level cache memory for reducing clean eviction in a cache memory hierarchy according to an aspect.

FIG. 11 is a process flow diagram illustrating a method for finding a victim cache line candidate in a higher level cache memory for reducing clean eviction in a cache memory hierarchy according to an aspect.

FIG. 12 is a process flow diagram illustrating a method for updating a lower level cache memory for reducing clean eviction in a cache memory hierarchy according to an aspect.

FIG. 13 is a process flow diagram illustrating a method for updating a lower level cache memory for reducing clean eviction I in a cache memory hierarchy according to an aspect.

FIG. 14 is a process flow diagram illustrating a method for reducing clean eviction in a cache memory hierarchy according to an aspect.

FIG. 15 is a process flow diagram illustrating a method for updating a lower level cache memory for reducing clean eviction in a cache memory hierarchy according to an aspect.

FIG. 16 is a component block diagram illustrating an example mobile computing device suitable for use with the various aspects.

FIG. 17 is a component block diagram illustrating an example mobile computing device suitable for use with the various aspects.

FIG. 18 is a component block diagram illustrating an example server suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various aspects may include methods, and computing devices executing such methods for implementing reducing clean eviction in exclusive lower level cache memory. The apparatus and methods of various aspects may include indicators of a cache line configured for tracking hits of the cache line, accesses of the cache line, changes to the data of the cache line, and/or an inclusion mode for the cache line. The apparatus and methods of various aspects may include identifying cache lines that are cycling between higher level cache memory (e.g., level 1 (L1) cache memory) and lower level cache memory (e.g., level 2 (L2) cache memory), consuming unnecessary bandwidth and power, and promoting such cache lines to an inclusive mode to reduce and/or eliminate clean evictions of the cache line in a cache memory hierarchy. The apparatus and methods of various aspects may include hybrid caches that apply different caching policies based on a type of cache access (e.g., load, store, read, or write), and back-up frequently used cache lines with clean data to reduce and/or avoid clean evictions of the cache line in a cache memory hierarchy by maintaining the cache line with clean data in an inclusive mode and maintaining the cache line with dirty data in an exclusive mode.

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The terms “computing device” and “mobile computing device” may further refer to Internet of Things (IoT) devices, including wired and/or wirelessly connectable appliances and peripheral devices to appliances, decor devices, security devices, environment regulator devices, physiological sensor devices, audio/visual devices, toys, hobby and/or work devices, IoT device hubs, etc. The terms “computing device” and “mobile computing device” may further refer to components of personal and mass transportation vehicles. The term “computing device” may further refer to stationary computing devices including personal computers, desktop computers, all-in-one computers, workstations, super computers, mainframe computers, embedded computers, servers, home media computers, and game consoles.

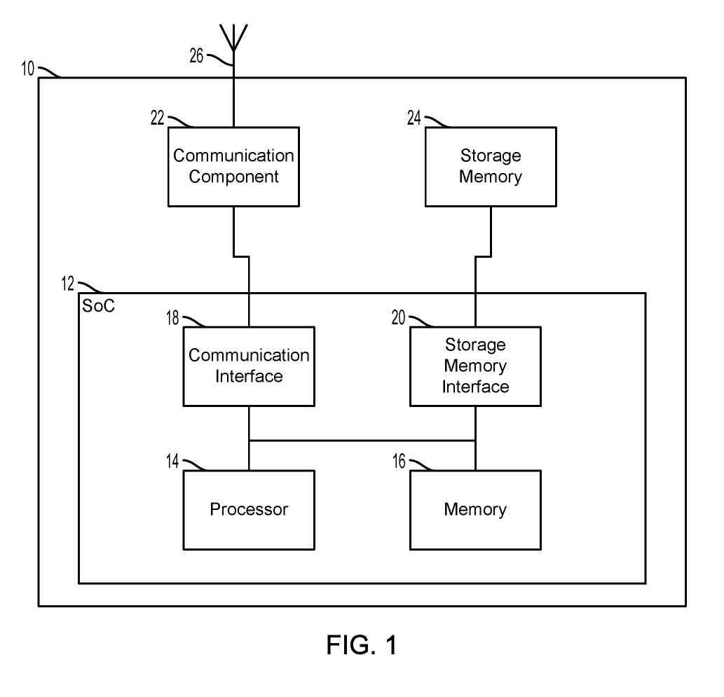

FIG. 1 illustrates a system including a computing device 10 suitable for use with the various aspects. The computing device 10 may include a system-on-chip (SoC) 12 with a processor 14, a memory 16, a communication interface 18, and a storage memory interface 20. The computing device 10 may further include a communication component 22, such as a wired or wireless modem, a storage memory 24, and an antenna 26 for establishing a wireless communication link. The processor 14 may include any of a variety of processing devices, for example a number of processor cores.

The term “system-on-chip” (SoC) is used herein to refer to a set of interconnected electronic circuits typically, but not exclusively, including a processing device, a memory, and a communication interface. A processing device may include a variety of different types of processors 14 and processor cores, such as a general purpose processor, a central processing unit (CPU), a digital signal processor (DSP), a graphics processing unit (GPU), an accelerated processing unit (APU), a subsystem processor of specific components of the computing device, such as an image processor for a camera subsystem or a display processor for a display, an auxiliary processor, a single-core processor, and a multicore processor. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

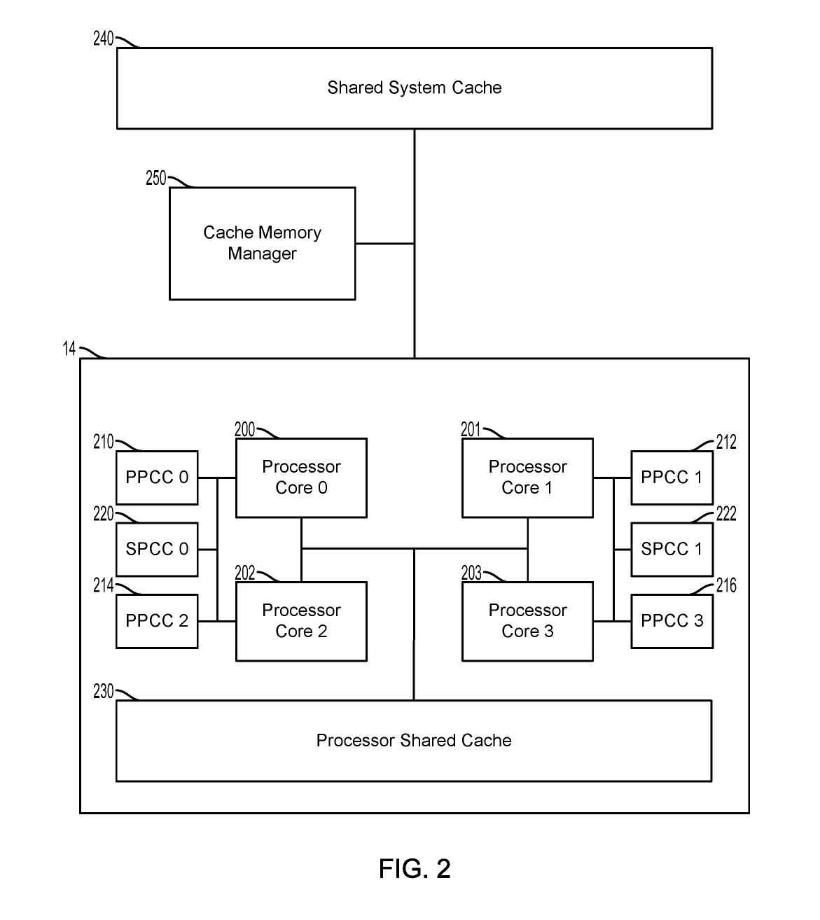

An SoC 12 may include one or more processors 14. The computing device 10 may include more than one SoC 12, thereby increasing the number of processors 14 and processor cores. The computing device 10 may also include processors 14 that are not associated with an SoC 12. Individual processors 14 may be multicore processors as described below with reference to FIG. 2. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16 of the SoC 12 may be a volatile or non-volatile memory configured for storing data and processor-executable code for access by the processor 14. The computing device 10 and/or SoC 12 may include one or more memories 16 configured for various purposes. One or more memories 16 may include volatile memories such as random access memory (RAM) or main memory, cache memory, or flash memory. These memories 16 may be configured to temporarily hold a limited amount of data received from a data sensor or subsystem, data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store data and processor-executable code, at least temporarily, that is loaded to the memory 16 from another memory device, such as another memory 16 or storage memory 24, for access by one or more of the processors 14. The data or processor-executable code loaded to the memory 16 may be loaded in response to execution of a function by the processor 14. Loading the data or processor-executable code to the memory 16 in response to execution of a function may result from a memory access request to the memory 16 that is unsuccessful, or a “miss,” because the requested data or processor-executable code is not located in the memory 16. In response to a miss, a memory access request to another memory 16 or storage memory 24 may be made to load the requested data or processor-executable code from the other memory 16 or storage memory 24 to the memory device 16. Loading the data or processor-executable code to the memory 16 in response to execution of a function may result from a memory access request to another memory 16 or storage memory 24, and the data or processor-executable code may be loaded to the memory 16 for later access.

The storage memory interface 20 and the storage memory 24 may work in unison to allow the computing device 10 to store data and processor-executable code on a non-volatile storage medium. The storage memory 24 may be configured much like an aspect of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be arranged differently and/or combined while still serving the functions of the various aspects. The computing device 10 may not be limited to one of each of the components, and multiple instances of each component may be included in various configurations of the computing device 10.

FIG. 2 illustrates components of a computing device suitable for implementing various aspects. The processor 14 may include multiple processor types, including, for example, a CPU and various hardware accelerators, such as a GPU, a DSP, an APU, subsystem processor, etc. The processor 14 may also include a custom hardware accelerator, which may include custom processing hardware and/or general purpose hardware configured to implement a specialized set of functions. The processors 14 may include any number of processor cores 200, 201, 202, 203. A processor 14 having multiple processor cores 200, 201, 202, 203 may be referred to as a multicore processor.

The processor 14 may have a plurality of homogeneous or heterogeneous processor cores 200, 201, 202, 203. A homogeneous processor may include a plurality of homogeneous processor cores. The processor cores 200, 201, 202, 203 may be homogeneous in that, the processor cores 200, 201, 202, 203 of the processor 14 may be configured for the same purpose and have the same or similar performance characteristics. For example, the processor 14 may be a general purpose processor, and the processor cores 200, 201, 202, 203 may be homogeneous general purpose processor cores. The processor 14 may be a GPU or a DSP, and the processor cores 200, 201, 202, 203 may be homogeneous graphics processor cores or digital signal processor cores, respectively. The processor 14 may be a custom hardware accelerator with homogeneous processor cores 200, 201, 202, 203.

A heterogeneous processor may include a plurality of heterogeneous processor cores. The processor cores 200, 201, 202, 203 may be heterogeneous in that the processor cores 200, 201, 202, 203 of the processor 14 may be configured for different purposes and/or have different performance characteristics. The heterogeneity of such heterogeneous processor cores may include different instruction set architecture, pipelines, operating frequencies, etc. An example of such heterogeneous processor cores may include what are known as “big.LITTLE” architectures in which slower, low-power processor cores may be coupled with more powerful and power-hungry processor cores. In similar aspects, an SoC (for example, SoC 12 of FIG. 1) may include any number of homogeneous or heterogeneous processors 14. In various aspects, not all off the processor cores 200, 201, 202, 203 need to be heterogeneous processor cores, as a heterogeneous processor may include any combination of processor cores 200, 201, 202, 203 including at least one heterogeneous processor core.

Each of the processor cores 200, 201, 202, 203 of a processor 14 may be designated a private processor core cache (PPCC) memory 210, 212, 214, 216 that may be dedicated for read and/or write access by a designated processor core 200, 201, 202, 203. The private processor core cache 210, 212, 214, 216 may store data and/or instructions, and make the stored data and/or instructions available to the processor cores 200, 201, 202, 203, to which the private processor core cache 210, 212, 214, 216 is dedicated, for use in execution by the processor cores 200, 201, 202, 203. The private processor core cache 210, 212, 214, 216 may include volatile memory as described herein with reference to memory 16 of FIG. 1.

Groups of the processor cores 200, 201, 202, 203 of a processor 14 may be designated a shared processor core cache (SPCC) memory 220, 222 that may be dedicated for read and/or write access by a designated group of processor core 200, 201, 202, 203. The shared processor core cache 220, 222 may store data and/or instructions, and make the stored data and/or instructions available to the group processor cores 200, 201, 202, 203 to which the shared processor core cache 220, 222 is dedicated for use in execution by the processor cores 200, 201, 202, 203 in the designated group. The shared processor core cache 220, 222 may include volatile memory as described herein with reference to memory 16 of FIG. 1.

The processor 14 may be designated a shared processor cache memory 230 that may be dedicated for read and/or write access by the processor cores 200, 201, 202, 203 of the processor 14. The shared processor cache 230 may store data and/or instructions, and make the stored data and/or instructions available to the processor cores 200, 201, 202, 203, for use in execution by the processor cores 200, 201, 202, 203. The shared processor cache 230 may also function as a buffer for data and/or instructions input to and/or output from the processor 14. The shared cache 230 may include volatile memory as described herein with reference to memory 16 of FIG. 1.

Multiple processors 14 may be designated a shared system cache memory 240 that may be dedicated for read and/or write access by the processor cores 200, 201, 202, 203 of the multiple processors 14. The shared system cache 240 may store data and/or instructions, and make the stored data and/or instructions available to the processor cores 200, 201, 202, 203, for use in execution by the processor cores 200, 201, 202, 203. The shared system cache 240 may also function as a buffer for data and/or instructions input to and/or output from the multiple processors 14. The shared system cache 240 may include volatile memory as described herein with reference to memory 16 of FIG. 1.

A cache memory manager 250 may be communicatively connected to a processor 14 and a cache memory 210, 212, 214, 216, 220, 222, 230, 240, and configured to control access to the cache memory 210, 212, 214, 216, 220, 222, 230, 240, and to manage and maintain the cache memory 210, 212, 214, 216, 220, 222, 230, 240. The cache memory manager 250 may be configured to pass and/or deny memory access requests to the cache memory 210, 212, 214, 216, 220, 222, 230, 240 from the processor, pass data and/or instructions to and from the cache memory 210, 212, 214, 216, 220, 222, 230, 240, and/or trigger maintenance and/or coherency operations for the cache memory 210, 212, 214, 216, 220, 222, 230, 240, including an eviction policy. In various aspects, the cache memory manager 250 may be a hardware component standalone from and/or integral to the processor 14. In various aspects, the cache memory manager 250 may be a software component configured to cause a dedicated hardware component and/or the processor 14 to execute operations for managing the cache memory 210, 212, 214, 216, 220, 222, 230, 240. In various aspects, any number of cache memory managers 250 may be associated with any number of cache memories 210, 212, 214, 216, 220, 222, 230, 240, including one-to-many, many-to-one, and one-to-one configurations. The terms “cache memory manager” and “cache memory controller” are used interchangeably throughout the descriptions.

In the example illustrated in FIG. 2, the processor 14 includes four processor cores 200, 201, 202, 203 (i.e., processor core 0, processor core 1, processor core 2, and processor core 3). In the illustrated example, each processor core 200, 201, 202, 203 is designated a respective private processor core cache 210, 212, 214, 216 (i.e., processor core 0 and private processor core cache 0, processor core 1 and private processor core cache 1, processor core 2 and private processor core cache 2, and processor core 3 and private processor core cache 3). The processor cores 200, 201, 202, 203 may be grouped, and each group may be designated a shared processor core cache 220, 222 (i.e., a group of processor core 0 and processor core 2 and shared processor core cache 0, and a group of processor core 1 and processor core 3 and shared processor core cache 1).

For ease of explanation, descriptions of various aspects may refer to the four processor cores 200, 201, 202, 203, the four private processor core caches 210, 212, 214, 216, two groups of processor cores 200, 201, 202, 203, and the shared processor core cache 220, 222 illustrated in FIG. 2. However, the four processor cores 200, 201, 202, 203, the four private processor core caches 210, 212, 214, 216, two groups of processor cores 200, 201, 202, 203, and the shared processor core cache 220, 222 illustrated in FIG. 2 and described herein are merely provided as an example and in no way are meant to limit the various aspects to a four-core processor system with four designated private processor core caches and two designated shared processor core caches 220, 222. The computing device 10, the SoC 12, or the processor 14 may individually or in combination include fewer or more than the four processor cores 200, 201, 202, 203 and private processor core caches 210, 212, 214, 216, and two shared processor core caches 220, 222 illustrated and described herein.

In various aspects, a processor core 200, 201, 202, 203 may access data and/or instructions stored in the shared processor core cache 220, 222, the shared processor cache 230, and/or the shared system cache 240 indirectly through access to data and/or instructions loaded to a higher level cache memory from a lower level cache memory. For example, levels of the various cache memories 210, 212, 214, 216, 220, 222, 230, 240 in descending order from highest level cache memory to lowest level cache memory may be the private processor core cache 210, 212, 214, 216, the shared processor core cache 220, 222, the shared processor cache 230, and the shared system cache 240. A higher level cache memory 210, 212, 214, 216, 220, 222, 230 may be any cache memory of a higher level than a lower level cache memory 220, 222, 230, 240. In various aspects, data and/or instructions may be loaded to a cache memory 210, 212, 214, 216, 220, 222, 230, 240 from a lower level cache memory 220, 222, 230, 240 and/or other memory (e.g., memory 16, 24 in FIG. 1) as a response to a miss the cache memory 210, 212, 214, 216, 220, 222, 230, 240 for a memory access request, and/or as a response to a prefetch operation speculatively retrieving data and/or instructions for future use by the processor core 200, 201, 202, 203. In various aspects, the cache memory 210, 212, 214, 216, 220, 222, 230, 240 may be managed using an eviction policy to replace data and/or instructions stored in the cache memory 210, 212, 214, 216, 220, 222, 230, 240 to allow for storing other data and/or instructions. Evicting data and/or instructions may include writing the evicted data and/or instructions evicted from a higher level cache memory 210, 212, 214, 216, 220, 222, 230 to a lower level cache memory 220, 222, 230, 240 and/or other memory.

For ease of reference, the terms “hardware accelerator,” “custom hardware accelerator,” “multicore processor,” “processor,” and “processor core” may be used interchangeably herein. The descriptions of the illustrated computing device and its various components are only meant to be examples and in no way limiting on the scope of the claims. Several of the components of the illustrated example computing device may be variably configured, combined, and separated. Several of the components may be included in greater or fewer numbers, and may be located and connected differently within the SoC or separate from the SoC.

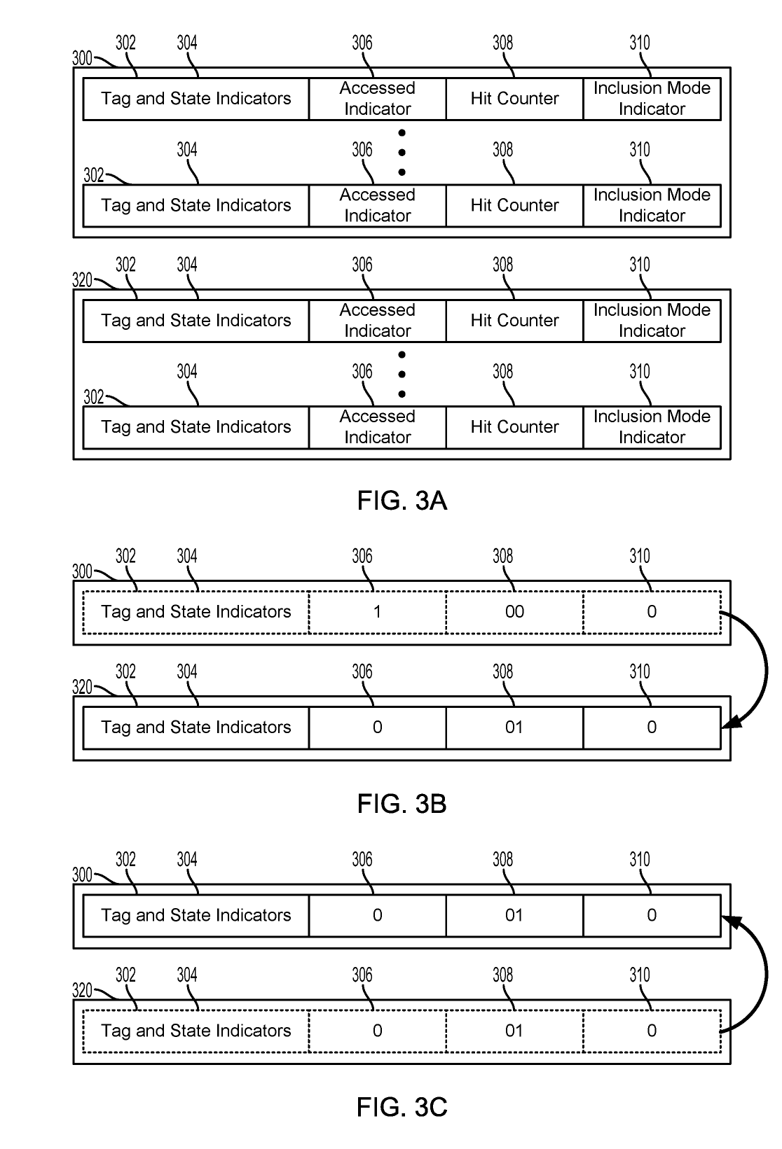

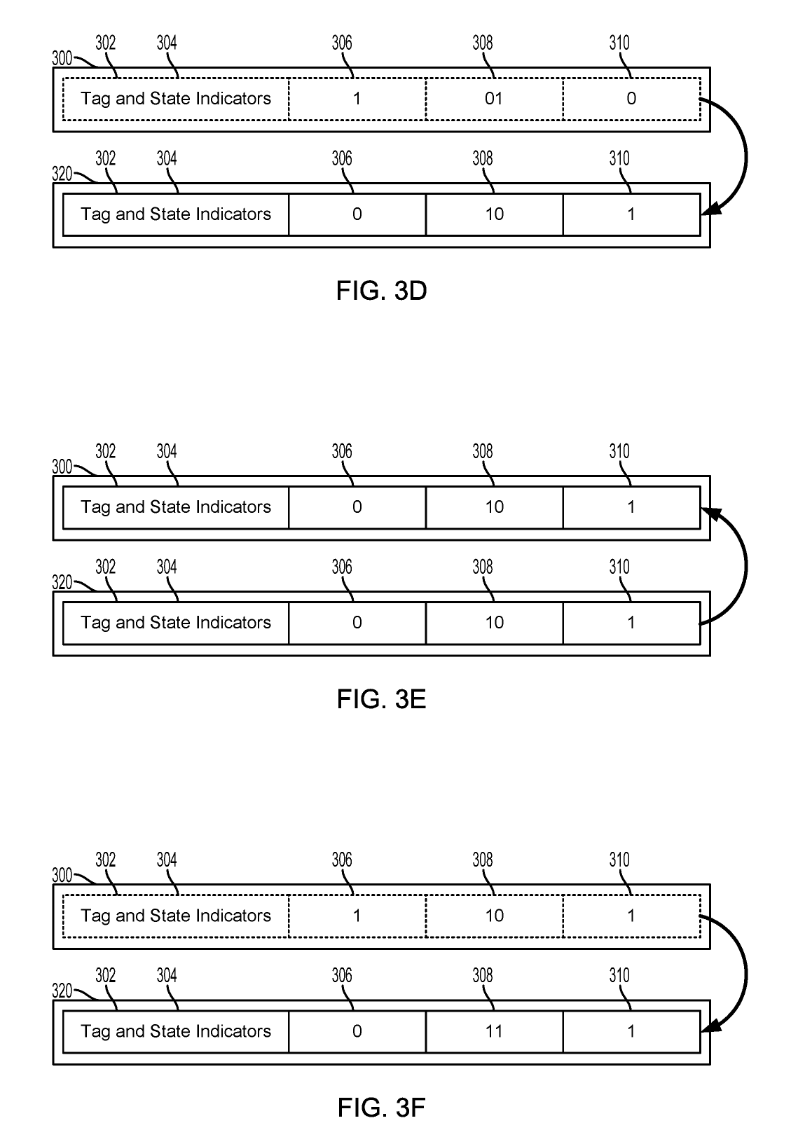

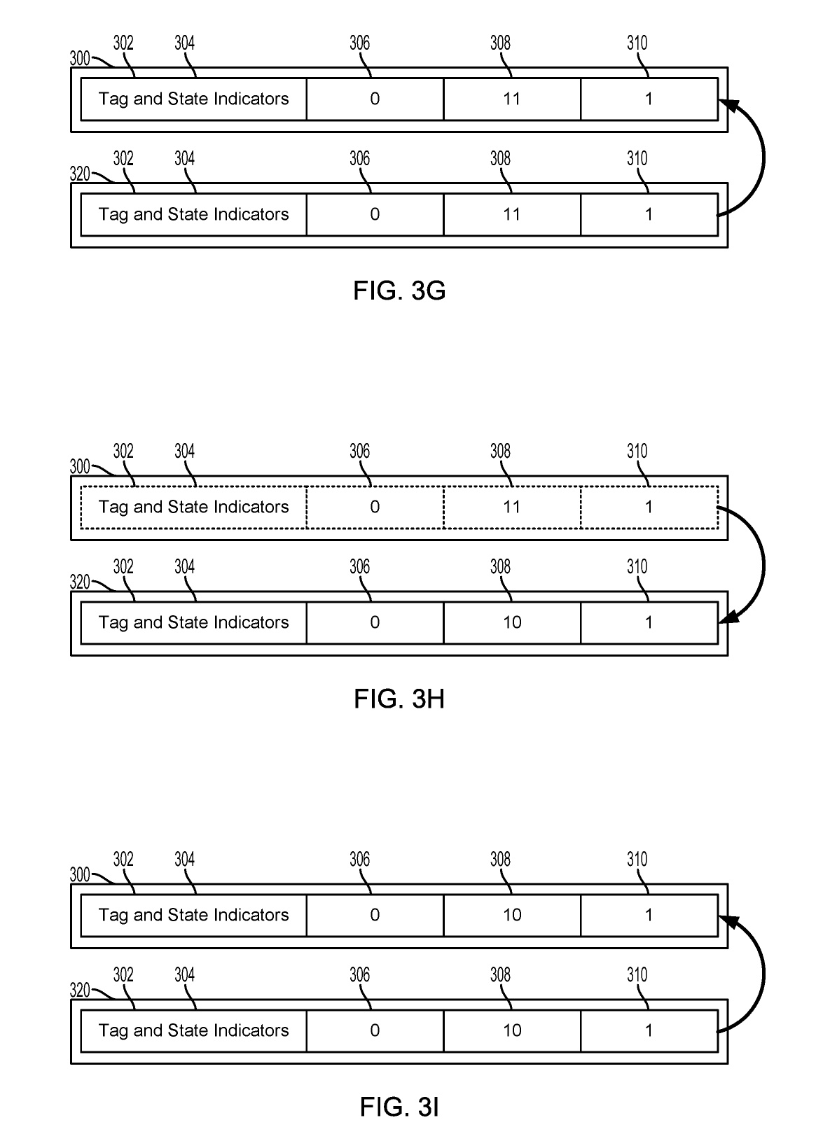

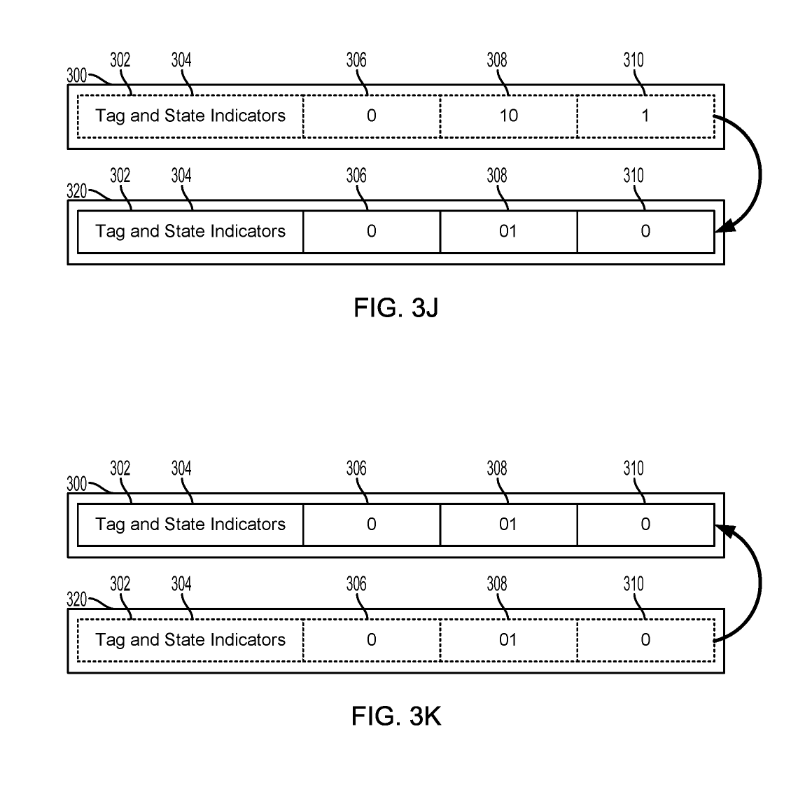

FIGS. 3A-3K illustrate examples of reducing clean eviction in a cache memory hierarchy in a system configured to promote high locality data to an inclusive mode suitable for implementing various aspects. FIGS. 3A-3K illustrate various aspects of a cache memory system configured to promote high locality data to an inclusive mode. The illustrated aspects may include a higher level cache memory 300 (e.g., higher level cache memory 210, 212, 214, 216, 220, 222, 230 in FIG. 2; e.g., level 1 (L1) cache memory and/or level 2 (L2) cache memory), a lower level cache memory 320 (e.g., lower level cache memory 220, 222, 230, 240 in FIG. 2, L2 cache memory, and/or level 3 (L3) cache memory), and any number of cache memory managers (e.g., cache memory manager 250 in FIG. 2). The higher level cache memory 300 may be any cache memory of a higher level than the lower level cache memory 320, including at least a last level cache memory, which may be a lowest level cache memory of the cache memory hierarchy.

A cache memory manager may be communicatively connected to a processor (e.g., processor 14 in FIGS. 1 and 2) and the higher level cache memory 300 and/or the lower level cache memory 320, and configured to control access to the higher level cache memory 300 and/or the lower level cache memory 320, and to manage and maintain the higher level cache memory 300 and/or the lower level cache memory 320. The cache memory manager may be configured to pass and/or deny memory access requests to the higher level cache memory 300 and/or the lower level cache memory 320 from the processor, pass data and/or instructions to and from the higher level cache memory 300 and/or the lower level cache memory 320, and/or trigger maintenance and/or coherency operations for the higher level cache memory 300 and/or the lower level cache memory 320, including an eviction policy. In various aspects, the higher level cache memory 300 and the lower level cache memory 320 may be associated with different cache memory managers.

FIG. 3A illustrates an example system configured to promote high locality data to an inclusive mode with a cache memory hierarchy having a higher level cache memory 300 and a lower level cache memory 320. The higher level cache memory 300 and the lower level cache memory 320 may be divided into any number of segments configured to store data and/or instructions of any size, such as a cache line 302, which may also be known as a cache block.

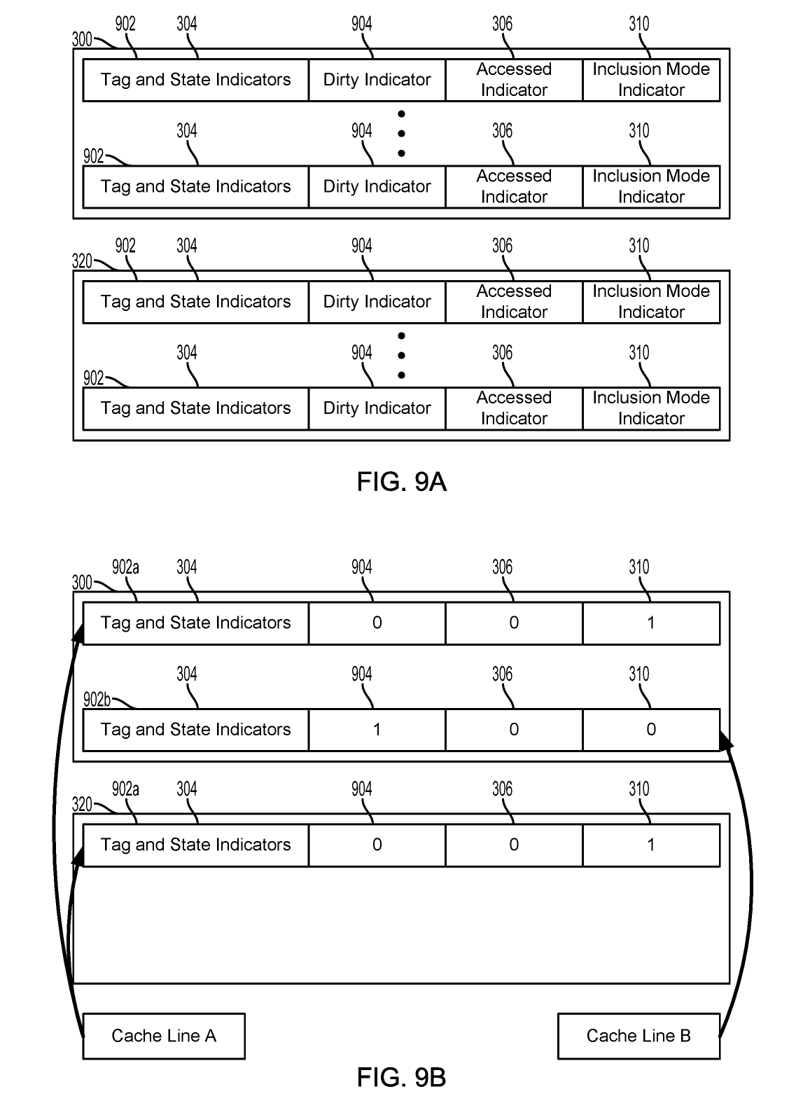

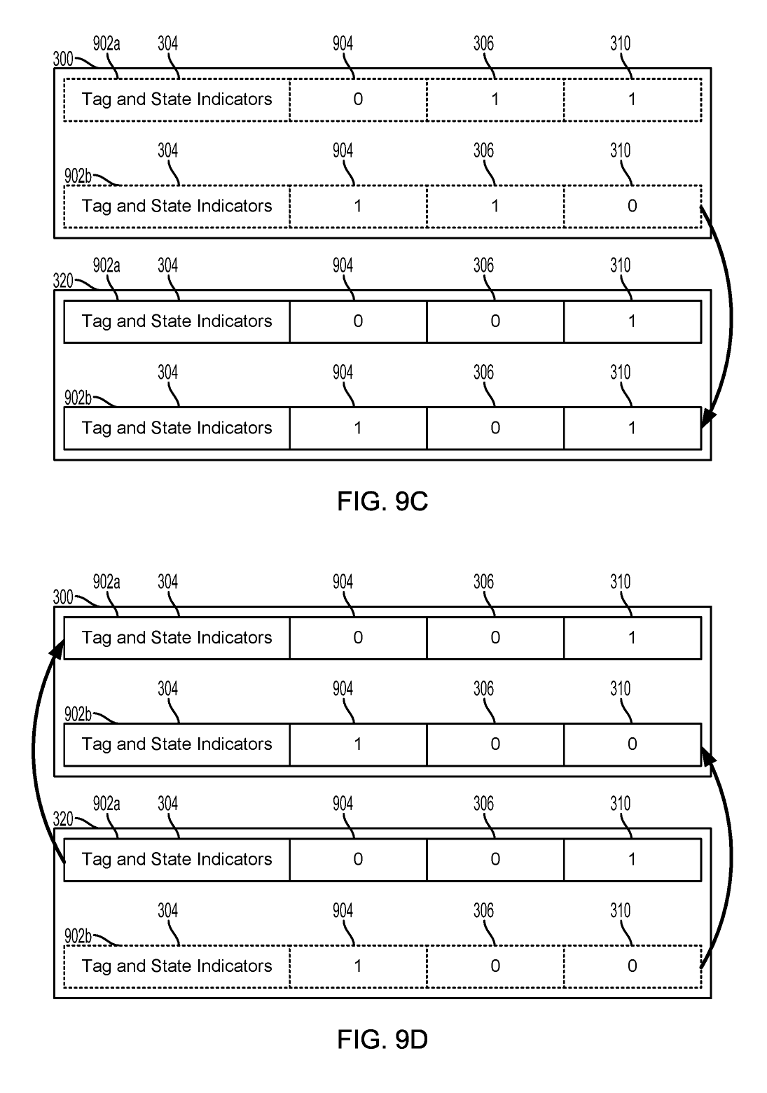

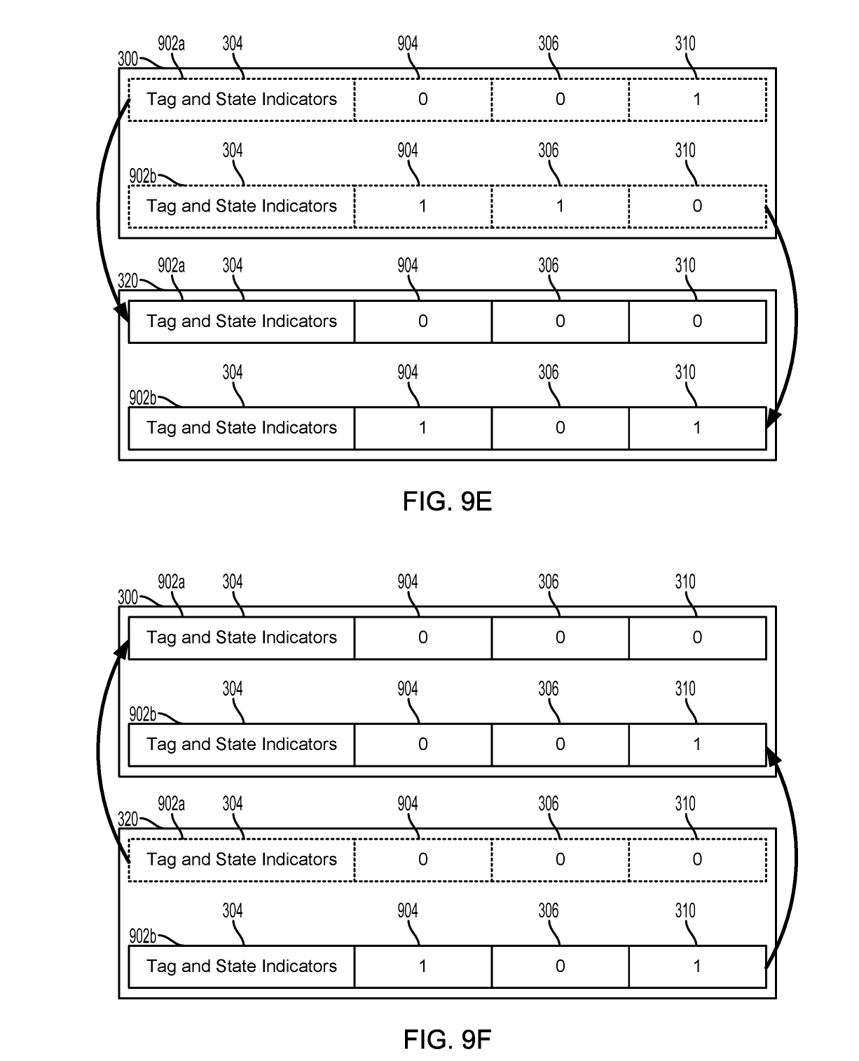

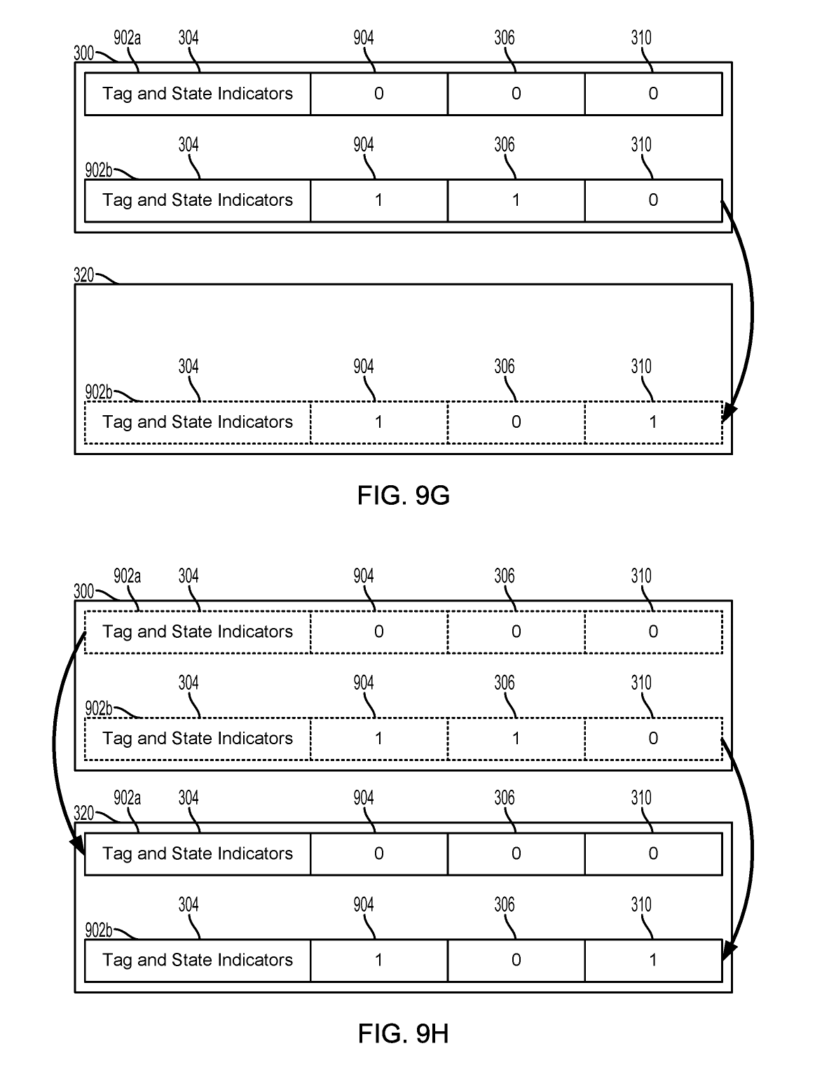

A cache line 302 may include data and/or instructions for use by an application executed by a processor and data configured to identify and configure the cache line 302. In various aspects the cache line 302 may include a fields for tag and state indicators 304, a field for an accessed indicator 306, a field for a hit counter 308, a field for an inclusion mode indicator 310, and/or a field for a dirty indicator (not shown in FIG. 3A but described herein with reference to FIGS. 9A-9H). The tag and state indicators 304 may be configured to identify the cache line 302 for access to the cache line 302. The accessed indicator 306 may be configured to indicate whether the cache line 302 is accessed, for example, while in the higher level cache memory 300 between an insertion into the higher level cache memory 300 and an eviction from the higher level cache memory 300, referred to herein as a tracking period. The hit counter 308 may be configured to indicate a locality of the cache line 302 for accesses in the higher level cache memory 300 across multiple tracking periods. The inclusion mode indicator 310 may be configured to indicate an inclusion mode of the cache line 302. The dirty indicator may be configured to indicate whether data of the cache line 302 is unmodified, referred to as clean data, or modified, referred to as dirty data.

In various aspects, the accessed indicator 306, the hit counter 308, the inclusion mode indicator 310, and the dirty indicator may be configured using various formats, data, and/or symbols, including any number and/or size. For the sake of example and ease of explanation, not meant to limit the scope of the descriptions and claims: the accessed indicator 306 may be a 1 bit binary indicator for which a “0” value may indicate the cache line 302 is not accessed and a “1” value may indicate the cache line 302 is accessed; the hit counter 308 may be a 2 bit binary counter for a range of values “00” to “11” which may indicate a locality value of the cache line 302; and the inclusion mode indicator 310 may be a 1 bit binary indicator for which a “0” value may indicate an exclusive mode for the cache line 302 and a “1” value may indicate an inclusive mode for the cache line 302. The higher level cache memory 300 and/or the lower level cache memory 320 may be configured as an exclusive cache memory, for which the cache line 302 in removed and/or invalidated in the higher level cache memory 300 and/or the lower level cache memory 320 in response to accesses of the cache line 302 that store the cache line 302 in the other of the higher level cache memory 300 and the lower level cache memory 320.

The cache line 302 may be sent back and forth between the higher level cache memory 300 and the lower level cache memory 320. The cache line 302 sent to either of the higher level cache memory 300 or the lower level cache memory 320 may be written to and stored in the higher level cache memory 300 or the lower level cache memory 320 to which the cache line 302 is sent. In various aspects, the cache line 302 in exclusive mode (i.e., inclusion mode indicator 310 having a value of “0”) may be removed from or invalidated in the higher level cache memory 300 or the lower level cache memory 320 from which the cache line 302 is sent. In various aspects, the cache line 302 in inclusive mode (i.e., inclusion mode indicator 310 having a value of “1”) may be maintained in the lower level cache memory 320.

The cache memory controller may be configured to update and analyze the cache line 302 in the higher level cache memory 300 and/or the lower level cache memory 320 sent between the higher level cache memory 300 and the lower level cache memory 320. In response to an access of the cache line 302 in the higher level cache memory 300, the cache memory controller may be configured to set the accessed indicator 306 of the cache line 302 in the higher level cache memory 300. In response to an eviction of the cache line 302 from the higher level cache memory 300, the cache memory controller may be configured to reset the accessed indicator 306 of the cache line 302 in the lower level cache memory 320.

In various aspects, setting the accessed indicator 306 may include writing a “1” value to the accessed indicator field of the cache line 302 to indicate that the cache line 302 is accessed, and resetting the accessed indicator 306 may include writing a “0” value to the accessed indicator field of the cache line 302 to indicate that the cache line 302 is not accessed. The cache memory manager may be configured to reset the accessed bit 306 for the cache line 302 sent to the lower level cache memory 320. In various aspects, for an accessed indicator 306 that is already the value for setting and/or resetting the accessed indicator 306, the cache memory manager may maintain the value of the accessed indicator 306 by setting and/or resetting the accessed indicator 306, and/or by skipping setting and/or resetting the accessed indicator 306.

In response to the cache line 302 being sent between the higher level cache memory 300 and the lower level cache memory 320, the cache memory controller may be configured to analyze the accessed indicator 306. The analysis of the accessed indicator 306 may result in updating the hit counter 308 in the higher level cache memory 300 and/or the lower level cache memory 320 to which the cache line 302 is sent. The cache memory manager may increase the hit counter 308 in response to the accessed indicator 306 being set, and may reduce the hit counter 308 in response to the accessed bit 306 not being set (i.e., having a “0” value) or reset. In various aspects, the hit counter 308 may be updated using various algorithms and/or operations.

In response to the cache line 302 being sent between the higher level cache memory 300 and the lower level cache memory 320, the cache memory controller may be configured to analyze the hit counter 308 for the cache line 302 being sent by comparing the hit counter 308 to an inclusion mode threshold. The comparison may be used to determine whether to set and/or reset the inclusion mode indicator 310. In various aspects, setting the inclusion mode indicator 310 may include writing a “1” value to the inclusion mode indicator field of the cache line 302 to indicate that the cache line 302 is in an inclusive mode. In various aspects, resetting the inclusion mode indicator 310 may include writing a “0” value to the inclusion mode indicator field of the cache line 302 to indicate that the cache line 302 is in an exclusive mode.

In various aspects, a hit counter 308 greater than (or equal to) the inclusion mode threshold may prompt the cache memory manager to set the inclusion mode indicator 310, and a hit counter 308 less than (or equal to) the inclusion mode threshold may prompt the cache memory manager to reset the inclusion mode indicator 310. In various aspects, for an inclusion mode indicator 310 that is already the value for setting and/or resetting the inclusion mode indicator 310, the cache memory manager may maintain the value of the inclusion mode indicator 310 by setting or resetting the inclusion mode indicator 310, or by skipping setting or resetting the inclusion mode indicator 310.

The cache memory controller may be configured to analyze the dirty indicator for the cache line 302 in response to an eviction of the cache line 302 from the higher level cache memory 300. The cache memory controller may determine that the eviction is a clean eviction in response to determining that the dirty indicator for the cache line 302 indicates that the data of the cache line 302 is not dirty, or is clean. For a clean eviction, the accessed indicator 306 for the cache line 302 may be sent from the higher level cache memory 300 to the lower level cache memory 320, and the rest of the cache line 302 may not be sent. The cache line 302 in the inclusive mode may be maintained in the lower level cache memory 320. The accessed indicator 306 may be sent for use in determining whether to update the hit counter 308 in cache line 302 in the lower level cache memory 320. Since the cache line 302 in the inclusive mode may be maintained in the lower level cache memory 320, the rest of the cache line 302 does not need to be sent back to the lower level cache memory 320. Sending only the accessed indicator 306 (what is referred to herein as “silently evicting”) may enable avoiding executing a clean eviction in which the entire cache line 302 would normally be sent. This may lower power consumed by avoiding repeated cache insertions and may reduce bandwidth usage by silently dropping clean data. Silently dropping the clean data may be accomplished by removal and/or invalidation of the date of the cache line 302 in the higher level cache memory 300 without sending the clean data to the lower level cache memory 320

The descriptions of the higher level cache memory 300, the lower level cache memory 320, the cache line 302, the accessed indicator 306, the hit counter 308, the inclusion mode indicator 310, and the dirty indicator also apply for like numbered elements shown in FIGS. 3B-3K. In various aspects, a cache line 302 inserted into the higher level cache memory 300 and/or the lower level cache memory 320 from another memory (e.g., memory 16, 24 in FIG. 1) may include a “0” value for the accessed indicator 306, a “00” value for the hit counter 308, and a “0” value (i.e., exclusive mode) for the inclusion mode indicator 310.

FIG. 3B illustrates the example system configured to promote high locality data to an inclusive mode with a cache memory hierarchy in which the cache line 302 is evicted from the higher level cache memory 300, and sent to the lower level cache memory 320. The cache line 302 may be stored in the higher level cache memory 300 and accessed during a tracking period prompting the cache memory manager to set the accessed indicator 306. The access to the cache line 302 in the higher level cache 300 may be an access that modifies the data of the cache line 302. Such an access may result in the dirty indicator indicating that the data of the cache line 302 in the higher level cache memory 300 is dirty.

In the example illustrated in FIG. 3B, the cache line 302 in the higher level cache memory 300 may include the set accessed indicator 306, the hit counter 308 indicating no access to the cache line 302 (e.g., the hit counter 308 may have the value “00”), and the not set, or reset, inclusion mode indicator 310 indicating that the cache line 302 is in the exclusive mode. The cache line 302 may be evicted from the higher level cache memory 300, removing and/or invalidating the exclusive mode cache line 302 in the higher level cache memory 300. The cache line 302 may be sent to the lower level cache memory 320. In response to the set accessed indicator 306, the cache memory manager may increase the hit counter 308, for example, from “00” to “01”. The cache memory manager may compare the updated hit counter 308 to the inclusion mode threshold and determine that the hit counter 308 does not exceed (or equal) the inclusion mode threshold, and the cache memory manager may maintain the inclusion mode indicator 310 of the cache line 302 in response. The cache memory manager may reset the accessed indicator 306.

FIG. 3C illustrates the example system configured to promote high locality data to an inclusive mode with a cache memory hierarchy in which the cache line 302 stored in the lower level cache memory 320 is sent to the higher level cache memory 300. The cache line 302 in the lower level cache memory 320 at the time of sending the cache line 302 to the higher level cache memory 300 may be the same as the cache line 302 in the lower level cache memory 320 as described for the example illustrated in FIG. 3B. In the example illustrated in FIG. 3C, the cache line 302 in the lower level cache memory 320 may include the not set, or reset, accessed indicator 306, the hit counter 308 indicating at least one access to the cache line 302 (e.g., the hit counter 308 may have the value “01”), and the not set, or reset, inclusion mode indicator 310 indicating that the cache line 302 is in the exclusive mode. The cache line 302 may be sent to the higher level cache memory 300, removing and/or invalidating the exclusive mode cache line 302 in the lower level cache memory 320. The cache memory manager may compare the hit counter 308 to the inclusion mode threshold and determine that the hit counter 308 does not exceed (or equal) the inclusion mode threshold, and the cache memory manager may maintain the inclusion mode indicator 310 of the cache line 302.

FIG. 3D illustrates the example system configured to promote high locality data to an inclusive mode with a cache memory hierarchy in which the cache line 302 is evicted from the higher level cache memory 300, and sent to the lower level cache memory 320. The cache line 302 in the higher level cache memory 300 prior to access of the cache line 302 in the higher level cache memory 300 may be the same as the cache line 302 in the higher level cache memory 300 as described for the example illustrated in FIG. 3C. The cache line 302 in the higher level cache memory 300 may be accessed during a tracking period prompting the cache memory manager to set the accessed indicator 306. The access to the cache line 302 in the higher level cache 300 may be an access that modifies the data of the cache line 302. Such an access may result in the dirty indicator indicating that the data of the cache line 302 in the higher level cache memory 300 is dirty. In the example illustrated in FIG. 3D, the cache line 302 in the higher level cache memory 300 may include the set accessed indicator 306, the hit counter 308 indicating at least one access to the cache line 302, and the not set, or reset, inclusion mode indicator 310 indicating that the cache line 302 is in the exclusive mode. The cache line 302 may be evicted from the higher level cache memory 300, removing and/or invalidating the exclusive mode cache line 302 in the higher level cache memory 300. The cache line 302 may be sent to the lower level cache memory 320. In response to the set accessed indicator 306, the cache memory manager may increase the hit counter 308, for example, from “01” to “10”. The cache memory manager may compare the updated hit counter 308 to the inclusion mode threshold and determine that the hit counter 308 does exceed (or equal) the inclusion mode threshold, and the cache memory manager may set the inclusion mode indicator 310 of the cache line 302 in response. The cache memory manager may reset the accessed indicator 306.

FIG. 3E illustrates the example system configured to promote high locality data to an inclusive mode with a cache memory hierarchy in which the cache line 302 stored in the lower level cache memory 320 is sent to the higher level cache memory 300. The cache line 302 in the lower level cache memory 320 at the time of sending the cache line 302 to the higher level cache memory 300 may be the same as the cache line 302 in the lower level cache memory 320 as described for the example illustrated in FIG. 3D. In the example illustrated in FIG. 3E, the cache line 302 in the lower level cache memory 320 may include the not set, or reset, accessed indicator 306, the hit counter 308 indicating multiple accesses to the cache line 302, and the set inclusion mode indicator 310 indicating that the cache line 302 is in the inclusive mode. The cache line 302 may be sent to the higher level cache memory 300, maintaining the inclusive mode cache line 302 in the lower level cache memory 320. The cache memory manager may compare the hit counter 308 to the inclusion mode threshold and determine that the hit counter 308 does exceed (or equal) the inclusion mode threshold, and the cache memory manager may maintain the inclusion mode indicator 310 of the cache line 302.

FIG. 3F illustrates the example system configured to promote high locality data to an inclusive mode with a cache memory hierarchy in which a clean eviction of the cache line 302 from the higher level cache memory 300 may be avoided, and only the accessed indicator 306 may be sent to the lower level cache memory 320. The cache line 302 in the higher level cache memory 300 prior to access of the cache line 302 in the higher level cache memory 300 may be the same as the cache line 302 in the higher level cache memory 300 as described for the example illustrated in FIG. 3E. The cache line 302 in the higher level cache memory 300 may be accessed during a tracking period prompting the cache memory manager to set the accessed indicator 306. The access to the cache line 302 in the higher level cache 300 may be an access that does not modify the data of the cache line 302. Such an access may result in the dirty indicator indicating that the data of the cache line 302 in the higher level cache memory 300 is clean. In the example illustrated in FIG. 3F, the cache line 302 in the higher level cache memory 300 may include the set accessed indicator 306, the hit counter 308 indicating multiple accesses to the cache line 302, and the set inclusion mode indicator 310 indicating that the cache line 302 is in the inclusive mode. The cache line 302 may be evicted from the higher level cache memory 300, removing and/or invalidating the inclusive mode cache line 302 in the higher level cache memory 300. The accessed indicator 306 of cache line 302 may be sent to the lower level cache memory 320. In response to the set accessed indicator 306, the cache memory manager may increase the hit counter 308, for example, from “10” to “11”. The cache memory manager may compare the updated hit counter 308 to the inclusion mode threshold and determine that the hit counter 308 does exceed (or equal) the inclusion mode threshold, and the cache memory manager may maintain the inclusion mode indicator 310 of the cache line 302 in response. The cache memory manager may reset the accessed indicator 306.

FIG. 3G illustrates the example system configured to promote high locality data to an inclusive mode with a cache memory hierarchy in which the cache line 302 stored in the lower level cache memory 320 is sent to the higher level cache memory 300. The cache line 302 in the lower level cache memory 320 at the time of sending the cache line 302 to the higher level cache memory 300 may be the same as the cache line 302 in the lower level cache memory 320 as described for the example illustrated in FIG. 3F. In the example illustrated in FIG. 3G, the cache line 302 in the lower level cache memory 320 may include the not set, or reset, accessed indicator 306, the hit counter 308 indicating multiple accesses to the cache line 302, and the set inclusion mode indicator 310 indicating that the cache line 302 is in the inclusive mode. The cache line 302 may be sent to the higher level cache memory 300, maintaining the inclusive mode cache line 302 in the lower level cache memory 320. The cache memory manager may compare the hit counter 308 to the inclusion mode threshold and determine that the hit counter 308 does exceed (or equal) the inclusion mode threshold, and the cache memory manager may maintain the inclusion mode indicator 310 of the cache line 302.

FIG. 3H illustrates the example system configured to promote high locality data to an inclusive mode with a cache memory hierarchy in which a clean eviction of the cache line 302 from the higher level cache memory 300 may be avoided, and only the accessed indicator 306 may be sent to the lower level cache memory 320. The cache line 302 in the higher level cache memory 300 may be the same as the cache line 302 in the higher level cache memory 300 as described for the example illustrated in FIG. 3G. The cache line 302 in the higher level cache memory 300 may not be accessed during a tracking period prompting the cache memory manager to not set, or reset, the accessed indicator 306. A lack of an access may result in the dirty indicator indicating that the data of the cache line 302 in the higher level cache memory 300 is clean. In the example illustrated in FIG. 3H, the cache line 302 in the higher level cache memory 300 may include the not set, or reset, accessed indicator 306, the hit counter 308 indicating multiple accesses to the cache line 302, and the set inclusion mode indicator 310 indicating that the cache line 302 is in the inclusive mode. The cache line 302 may be evicted from the higher level cache memory 300, removing and/or invalidating the inclusive mode cache line 302 in the higher level cache memory 300. The accessed indicator 306 of cache line 302 may be sent to the lower level cache memory 320. In response to the not set, or reset, accessed indicator 306, the cache memory manager may decrease the hit counter 308, for example, from “11” to “10”. The cache memory manager may compare the updated hit counter 308 to the inclusion mode threshold and determine that the hit counter 308 does exceed (or equal) the inclusion mode threshold, and the cache memory manager may maintain the inclusion mode indicator 310 of the cache line 302. The cache memory manager may reset the accessed indicator 306.

FIG. 3I illustrates the example system configured to promote high locality data to an inclusive mode with a cache memory hierarchy in which the cache line 302 stored in the lower level cache memory 320 is sent to the higher level cache memory 300. The cache line 302 in the lower level cache memory 320 at the time of sending the cache line 302 to the higher level cache memory 300 may be the same as the cache line 302 in the lower level cache memory 320 as described for the example illustrated in FIG. 3H. In the example illustrated in FIG. 3I, the cache line 302 in the lower level cache memory 320 may include the not set, or reset, accessed indicator 306, the hit counter 308 indicating multiple accesses to the cache line 302, and the set inclusion mode indicator 310 indicating that the cache line 302 is in the inclusive mode. The cache line 302 may be sent to the higher level cache memory 300, maintaining the inclusive mode cache line 302 in the lower level cache memory 320. The cache memory manager may compare the hit counter 308 to the inclusion mode threshold and determine that the hit counter 308 does exceed (or equal) the inclusion mode threshold, and the cache memory manager may maintain the inclusion mode indicator 310 of the cache line 302 in response.

FIG. 3J illustrates the example system configured to promote high locality data to an inclusive mode with a cache memory hierarchy in which a clean eviction of the cache line 302 from the higher level cache memory 300 may be avoided, and only the accessed indicator 306 may be sent to the lower level cache memory 320. The cache line 302 in the higher level cache memory 300 may be the same as the cache line 302 in the higher level cache memory 300 as described for the example illustrated in FIG. 3I. The cache line 302 in the higher level cache memory 300 may not be accessed during a tracking period prompting the cache memory manager to not set, or reset, the accessed indicator 306. A lack of an access may result in the dirty indicator indicating that the data of the cache line 302 in the higher level cache memory 300 is clean. In the example illustrated in FIG. 3J, the cache line 302 in the higher level cache memory 300 may include the not set, or reset, accessed indicator 306, the hit counter 308 indicating multiple accesses to the cache line 302, and the set inclusion mode indicator 310 indicating that the cache line 302 is in the inclusive mode. The cache line 302 may be evicted from the higher level cache memory 300, removing and/or invalidating the inclusive mode cache line 302 in the higher level cache memory 300. The accessed indicator 306 of cache line 302 may be sent to the lower level cache memory 320. In response to the not set, or reset, accessed indicator 306, the cache memory manager may decrease the hit counter 308, for example, from “10” to “01”. The cache memory manager may compare the updated hit counter 308 to the inclusion mode threshold and determine that the hit counter 308 does not exceed (or equal) the inclusion mode threshold, and the cache memory manager may reset the inclusion mode indicator 310 of the cache line 302 in response. The cache memory manager may reset the accessed indicator 306.

FIG. 3K illustrates the example system configured to promote high locality data to an inclusive mode with a cache memory hierarchy in which the cache line 302 stored in the lower level cache memory 320 is sent to the higher level cache memory 300. The cache line 302 in the lower level cache memory 320 at the time of sending the cache line 302 to the higher level cache memory 300 may be the same as the cache line 302 in the lower level cache memory 320 as described for the example illustrated in FIG. 3J. In the example illustrated in FIG. 3I, the cache line 302 in the lower level cache memory 320 may include the not set, or reset, accessed indicator 306, the hit counter 308 indicating at least one access to the cache line 302, and the not set, or reset, inclusion mode indicator 310 indicating that the cache line 302 is in the exclusive mode. The cache line 302 may be sent to the higher level cache memory 300, removing and/or invalidating the exclusive mode cache line 302 in the lower level cache memory 320. The cache memory manager may compare the hit counter 308 to the inclusion mode threshold and determine that the hit counter 308 does not exceed (or equal) the inclusion mode threshold, and the cache memory manager may maintain the inclusion mode indicator 310 of the cache line 302 in response.

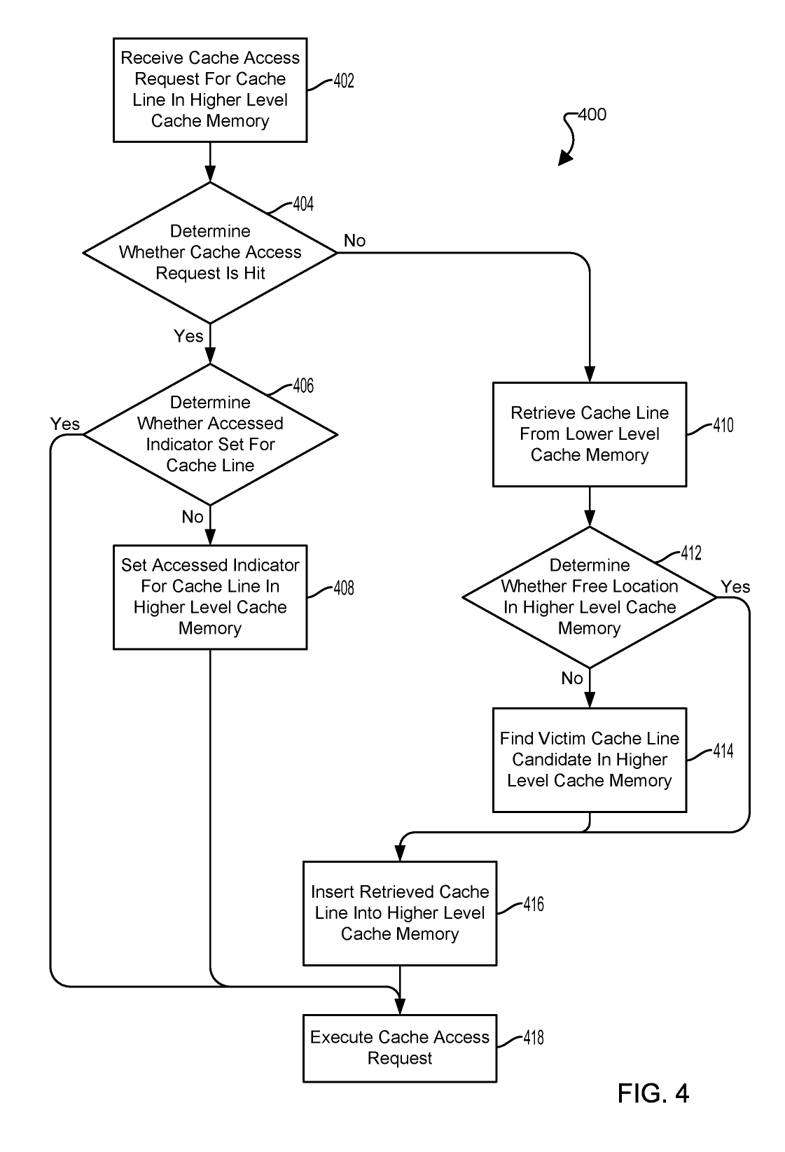

FIG. 4 illustrates a method 400 for reducing clean eviction in a cache memory hierarchy according to an aspect. The method 400 may be implemented in a computing device in software executing in a processor (e.g., the processor 14 in FIGS. 1 and 2), in general purpose hardware, in dedicated hardware (e.g., cache memory manager 250 in FIG. 2), or in a combination of a software-configured processor and dedicated hardware (e.g., processor 14 in FIGS. 1 and 2 and cache memory manager 250 in FIG. 2), such as a processor executing software within a cache memory hierarchy management system (e.g., system configured to promote high locality data to an inclusive mode in FIGS. 3A-3K, system configured to relax exclusivity requirements in FIGS. 9A-9H) that includes other individual components (e.g., memory 16, 24 in FIG. 1, higher level cache memory 300, lower level cache memory 320 in FIGS. 3A-3K and 9A-9H), and various memory/cache controllers. In order to encompass the alternative configurations enabled in various aspects, the hardware implementing the method 400 is referred to herein as a “processing device.”

In block 402, the processing device may receive a cache access request for a cache line in a higher level cache memory. The cache access request may be issued for an application executing on a computing device (e.g., computing device 10 in FIG. 1). The cache access request may include a read, write, load, and/or store cache access request.

In determination block 404, the processing device may determine whether cache access request results in a hit for the targeted cache line in the higher level cache memory. In various aspects, the processing device may check directly in the higher level cache memory and/or check a snoop directory of the higher level cache memory to determine whether the targeted cache line is stored in the higher level cache memory. Determining from the check that the targeted cache line is stored in the higher level cache memory may indicate that the cache access request results in a “hit” for the targeted cache line in the higher level cache memory. Determining from the check that the targeted cache line is not stored in the higher level cache memory may indicate that the cache access request results in a “miss” for the targeted cache line in the higher level cache memory.

In response to determining that the cache access request results in a hit for the targeted cache line in the higher level cache memory (i.e., determination block 404=“Yes”), the processing device may determine whether an accessed indicator is set for the cache line in determination block 406. The processing device may access the cache line in the higher level cache memory and check an accessed indicator field of the cache line for the accessed indicator. The processing device may determine from the accessed indicator whether the accessed indicator is set. For example, as discussed herein, a value of a binary format accessed indicator=“1” may indicate that the accessed indicator is set, and a value of the binary format accessed indicator=“0” may indicate that the accessed indicator is not set, or reset.

In response to determining that the accessed indicator is not set for the cache line (i.e., determination block 406=“No”), the processing device may set an accessed indicator for cache line in the higher level cache memory in block 408. The processing device may access the cache line in the higher level cache memory and write a designated value to the accessed indicator field of the cache line to set the accessed indicator. For example, the processing device may write a binary value=“1” for a binary format accessed indicator. The processing device may use any algorithms and/or operations to set accessed indicator for cache line in the higher level cache memory.

After setting the accessed indicator for cache line in the higher level cache memory in block 408 or in response to determining that the accessed indicator is set for the cache line (i.e., determination block 406=“Yes”), the processing device may execute the cache access request for the cache line in the higher level cache memory in block 418. In various aspects, the processing device may access the cache line in the higher level cache memory and retrieve from and/or write to the cache line data and/or instructions.

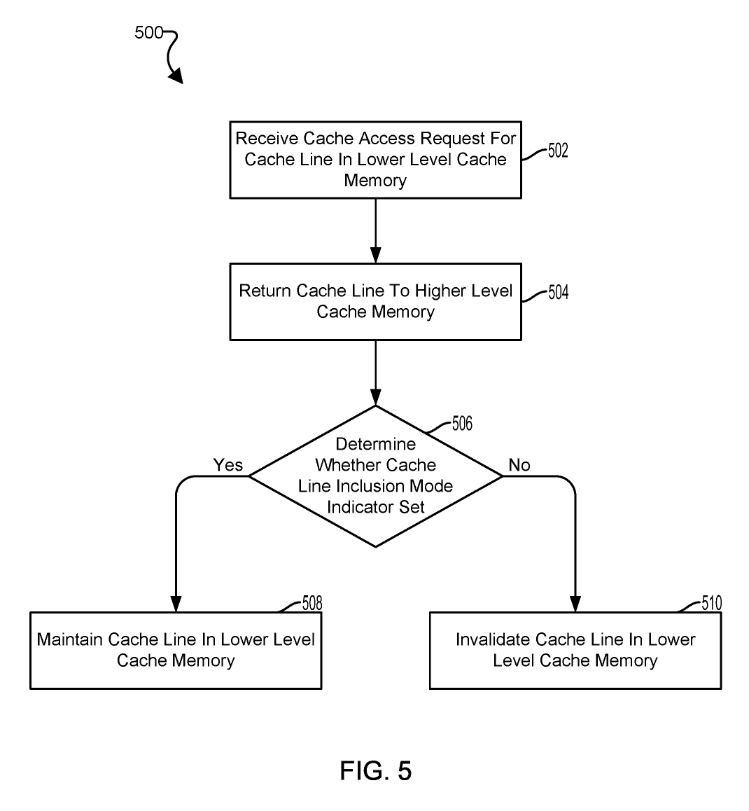

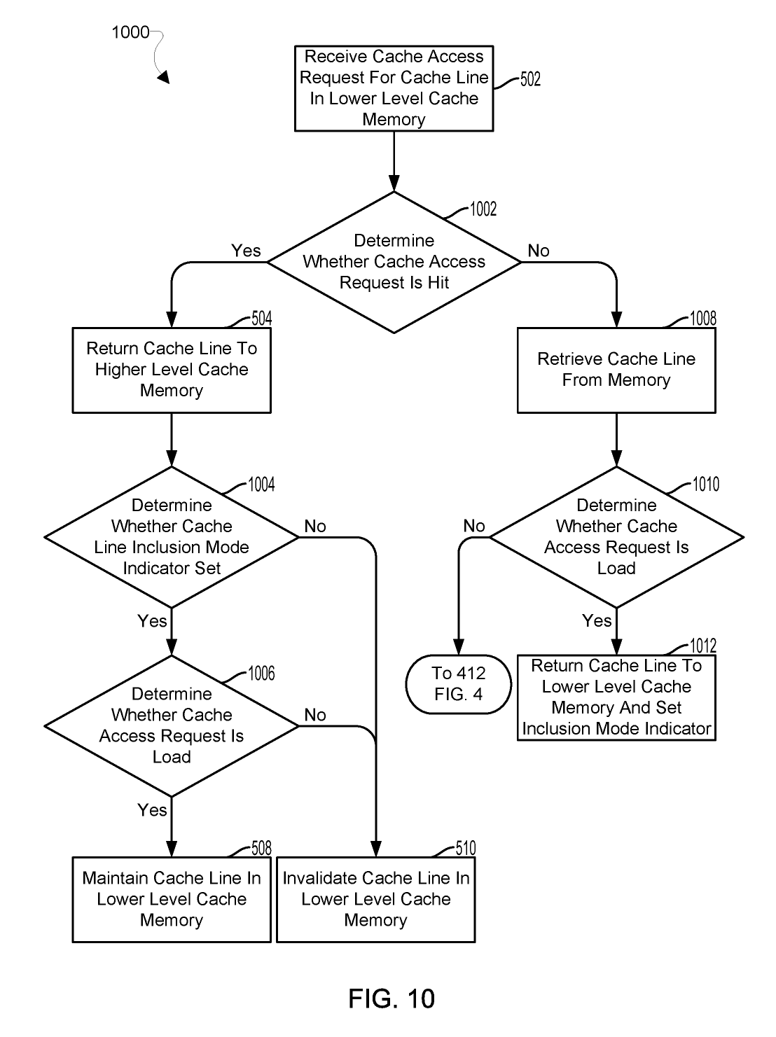

In response to determining that the cache access request does not result in a hit for the targeted cache line in the higher level cache memory (i.e., determination block 404=“No”), the processing device may retrieve the cache line from a lower level cache memory in block 410. The processing device may make a cache access request to the lower level cache memory for the cache line and determine whether cache access request to the lower level cache memory results in a hit in the lower level cache memory. In response to determining that cache access request to the lower level cache memory for the cache line results in a hit, the processing device may retrieve the cache line from the lower level cache and store the cache line in the higher level cache. In response to determining that cache access request to the lower level cache memory for the cache line does not result in a hit, the processing device may retrieve the cache line from another memory (e.g., memory 16, 24 in FIG. 1) and store the cache line in the higher level cache. Examples of operations that may be involved in retrieving the cache line from a lower level cache memory in block 410 are described with reference to the method 500 illustrated in FIG. 5 and the method 1000 illustrated in FIG. 10.

In determination block 412, the processing device may determine whether a free location is available in the higher level cache memory. The processing device may check directly in the higher level cache memory, may check a snoop directory, and/or check a cache memory usage and/or availability table for a free location in the higher level cache memory.

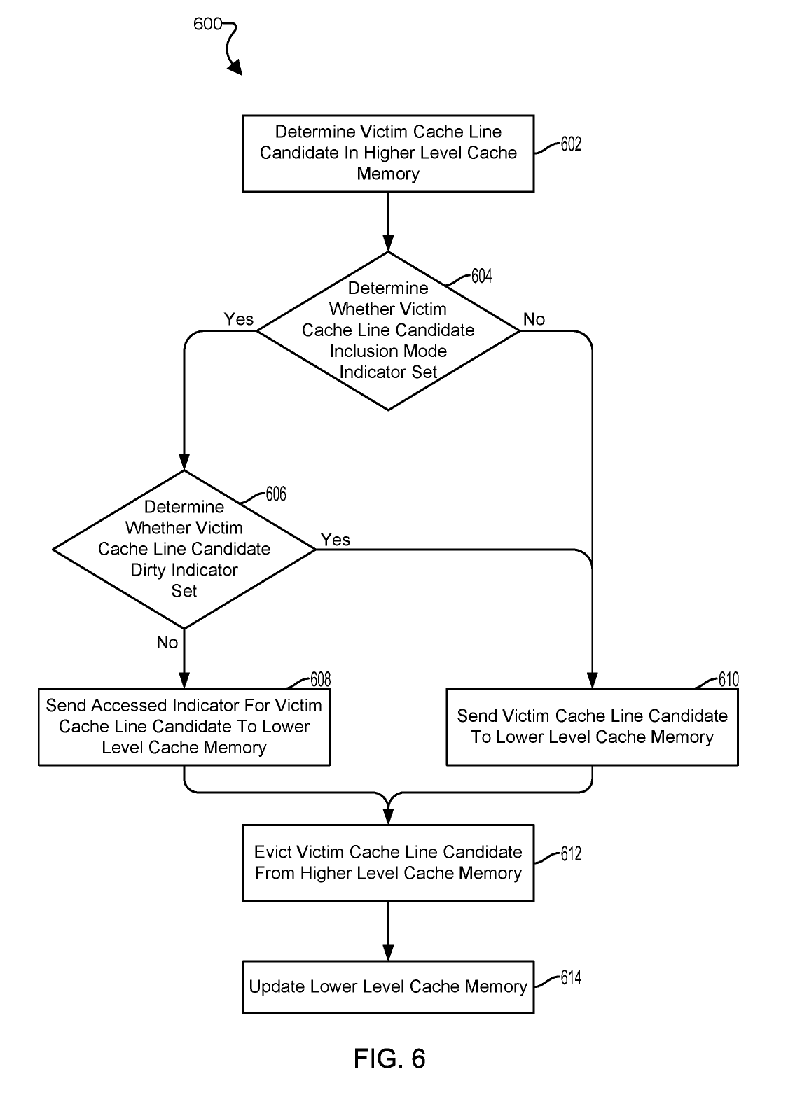

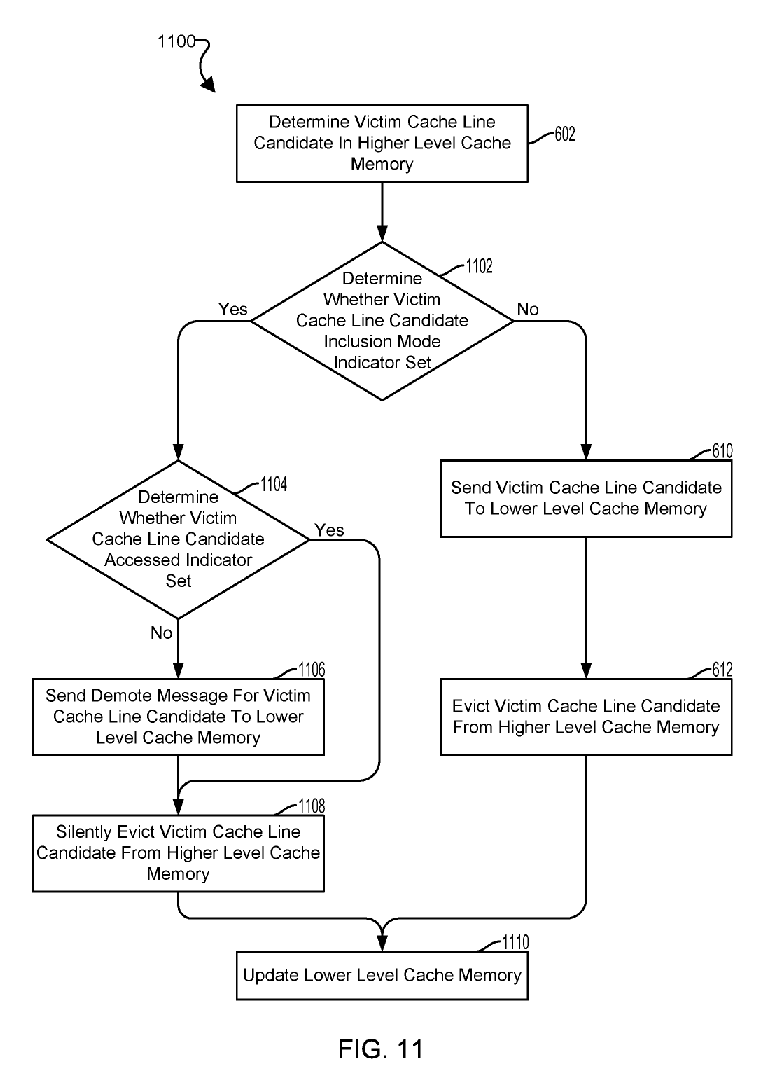

In response to determining that a free location is not available in the higher level cache memory (i.e., determination block 412=“No”), the processing device may find a victim cache line candidate in the higher level cache memory in block 414. A victim cache line candidate may be a cache line in the higher level cache memory that may be evicted from the higher level cache memory, thereby freeing a location in the higher level cache memory into which may be inserted the cache line retrieved from the lower level cache memory in block 410. In various aspects, the processing device may use any eviction criteria, such as least recently used, not most recently used, first in first out, etc. to find the victim cache line candidate. Examples of operations that may be involved in finding a victim cache line candidate in the higher level cache memory in block 414 are described with reference to the method 600 illustrated in FIG. 6 and the method 1100 illustrated in FIG. 11.

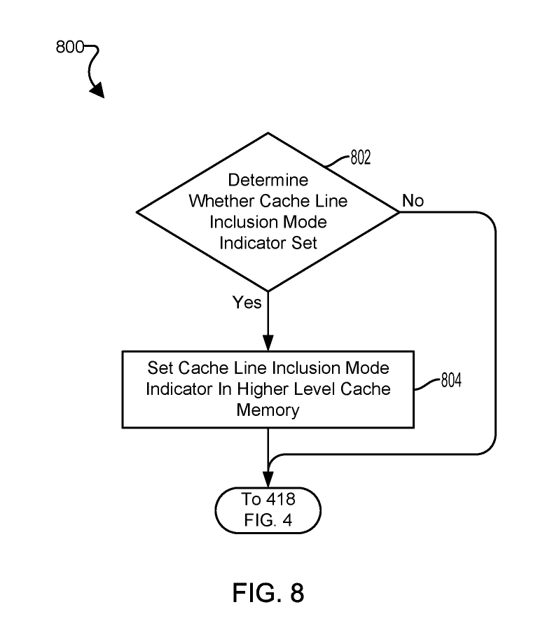

After finding a victim cache line candidate in the higher level cache memory in block 414 or in response to determining that a free location is available in the higher level cache memory (i.e., determination block 412=“Yes”), the processing device may insert retrieved cache line into higher level cache memory in block 416. The processing device may write the contents of the cache line retrieved from the lower level cache memory to the free location in the higher level cache memory. Examples of operations that may be involved in inserting retrieved cache line into higher level cache memory in block 416 may are described with reference to the method 800 illustrated in FIG. 8.

FIG. 5 illustrates a method 500 for retrieving a cache line from a lower level cache memory for reducing clean eviction in a cache memory hierarchy according to an aspect. The method 500 may be implemented in a computing device in software executing in a processor (e.g., the processor 14 in FIGS. 1 and 2), in general purpose hardware, in dedicated hardware (e.g., cache memory manager 250 in FIG. 2), or in a combination of a software-configured processor and dedicated hardware (e.g., processor 14 in FIGS. 1 and 2 and cache memory manager 250 in FIG. 2), such as a processor executing software within a cache memory hierarchy management system (e.g., system configured to promote high locality data to an inclusive mode in FIGS. 3A-3K, system configured to relax exclusivity requirements in FIGS. 9A-9H) that includes other individual components (e.g., memory 16, 24 in FIG. 1, higher level cache memory 300, lower level cache memory 320 in FIGS. 3A-3K and 9A-9H), and various memory/cache controllers. In order to encompass the alternative configurations enabled in various aspects, the hardware implementing the method 500 is referred to herein as a “processing device.” The method 500 includes operations that may be involved in retrieving the cache line from a lower level cache memory in block 410 of the method 400 described with reference to FIG. 4.

In block 502, the processing device may receive a cache access request for the cache line in the lower level cache memory. The cache access request may include a read, write, load, and/or store cache access request.

In block 504, the processing device may return the cache line to the higher level cache memory. In various aspects, the cache access request for the cache line in the lower level cache memory may result in a hit for the cache line, and the cache line may be returned to higher level cache memory. In various aspects, the cache access request for the cache line in the lower level cache memory may result in a miss for the cache line, and the cache line may be retrieved from another memory (e.g., memory 16, 24 in FIG. 1) and returned first from the other memory to the lower level cache memory and then from the lower level cache memory to higher level cache memory, and/or directly from the other memory to the higher level cache memory.

In determination block 506, the processing device may determine whether the cache line inclusion mode indicator is set. The processing device may access the cache line in the lower level cache memory and check an inclusion mode indicator field of the cache line for the inclusion mode indicator. The processing device may determine from the inclusion mode indicator whether the inclusion mode indicator is set. For example, as discussed herein, a value of a binary format inclusion mode indicator=“1” may indicate that the inclusion mode indicator is set, and a value of the binary format inclusion mode indicator=“0” may indicate that the inclusion mode indicator is not set, or reset.

In response to determining that the cache line inclusion mode indicator is set (i.e., determination block 506=“Yes”), the processing device may maintain the cache line in the lower level cache memory in block 508. Maintaining the cache line in the lower level cache memory may include keeping a copy of the cache line returned to the higher level cache memory in the lower level cache memory. To keep the copy of the cache line in the lower level cache memory the processing device may not evict, remove, and/or invalidate the cache line from the lower level cache memory.

In response to determining that the cache line inclusion mode indicator is not set (i.e., determination block 506=“No”), the processing device may invalidate the cache line in the lower level cache memory in block 510. The processing device may invalidate the cache line returned to the higher level cache memory by marking the cache line invalid in the lower level cache memory. In various aspects, the processing device may remove and/or evict the cache line from the lower level cache memory.

FIG. 6 illustrates a method 600 for finding a victim cache line candidate in a higher level cache memory for reducing clean eviction in a cache memory hierarchy according to an aspect. The method 600 may be implemented in a computing device in software executing in a processor (e.g., the processor 14 in FIGS. 1 and 2), in general purpose hardware, in dedicated hardware (e.g., cache memory manager 250 in FIG. 2), or in a combination of a software-configured processor and dedicated hardware (e.g., processor 14 in FIGS. 1 and 2 and cache memory manager 250 in FIG. 2), such as a processor executing software within a cache memory hierarchy management system (e.g., system configured to promote high locality data to an inclusive mode in FIGS. 3A-3K, system configured to relax exclusivity requirements in FIGS. 9A-9H) that includes other individual components (e.g., memory 16, 24 in FIG. 1, higher level cache memory 300, lower level cache memory 320 in FIGS. 3A-3K and 9A-9H), and various memory/cache controllers. In order to encompass the alternative configurations enabled in various aspects, the hardware implementing the method 600 is referred to herein as a “processing device.” The method 600 includes operations that may be involved in finding a victim cache line candidate in the higher level cache memory in block 414 of the method 400 as described with reference to FIG. 4.

In block 602, the processing device may determine the victim cache line candidate in the higher level cache memory. In various aspects, the processing device may use any eviction criteria, such as least recently used, not most recently used, first in first out, etc., to determine the victim cache line candidate.

In determination block 604, the processing device may determine whether the victim cache line candidate inclusion mode indicator is set. The processing device may access the victim cache line candidate in the higher level cache memory and check an inclusion mode indicator field of the victim cache line candidate for the inclusion mode indicator. The processing device may determine from the inclusion mode indicator whether the inclusion mode indicator is set. For example, as discussed herein, a value of a binary format inclusion mode indicator=“1” may indicate that the inclusion mode indicator is set, and a value of the binary format inclusion mode indicator=“0” may indicate that the inclusion mode indicator is not set, or reset.

In response to determining that the victim cache line candidate inclusion mode indicator is set (i.e., determination block 604=“Yes”), the processing device may determine whether the victim cache line candidate dirty indicator is set in determination block 606. The processing device may access the victim cache line candidate in the higher level cache memory and check a dirty indicator field of the victim cache line candidate for the dirty indicator. The processing device may determine from the dirty indicator whether the dirty indicator is set. For example, as discussed herein, a value of a binary format dirty indicator=“1” may indicate that the dirty indicator is set, and a value of the binary format dirty indicator=“0” may indicate that the dirty indicator is not set, or reset.

In response to determining that the victim cache line candidate dirty indicator is not set (i.e., determination block 606=“No”), the processing device may send an accessed indicator for victim cache line candidate to the lower level cache memory in block 608. The processing device may access the victim cache line candidate in the higher level cache memory and retrieve the accessed indicator from an accessed indicator field of the victim cache line candidate. The processing device may send the accessed indicator to the lower level cache memory alone and/or as part of a message to increase and/or decrease a hit counter of the cache line in the lower level cache memory that corresponds with the victim cache line candidate in the higher level cache memory. The cache line in the lower level cache memory that corresponds with the victim cache line candidate in the higher level cache memory may be referred to herein as the victim cache line in the lower level cache memory. The processing device may send the accessed indicator without sending other portions of the victim cache line candidate in the higher level cache memory.

In response to determining that the victim cache line candidate inclusion mode indicator is not set (i.e., determination block 604=“No”) or in response to determining that the victim cache line candidate dirty indicator is set (i.e., determination block 606=“Yes”), the processing device may send the victim cache line candidate to the lower level cache memory in block 610. The processing device may access the victim cache line candidate in the higher level cache memory and retrieve any combination, including all, of data stored in the victim cache line candidate, including the tag and state indicators, the accessed indicator, the inclusion mode indicator, the dirty indicator, and/or data and/or instructions for implementing the application executing on the computing device (e.g., computing device 10 in FIG. 1). The processing device may send the victim cache line candidate to the lower level cache memory for use in updating the victim cache line in the lower level cache memory.

In block 612, the processing device may evict the victim cache line candidate from the higher level cache memory. In various aspects, the processing device may evict the victim cache line candidate by marking the victim cache line candidate invalid in the higher level cache memory, by removing the victim cache line candidate from the higher level cache memory, and/or overwriting the victim cache line candidate in the higher level cache memory.

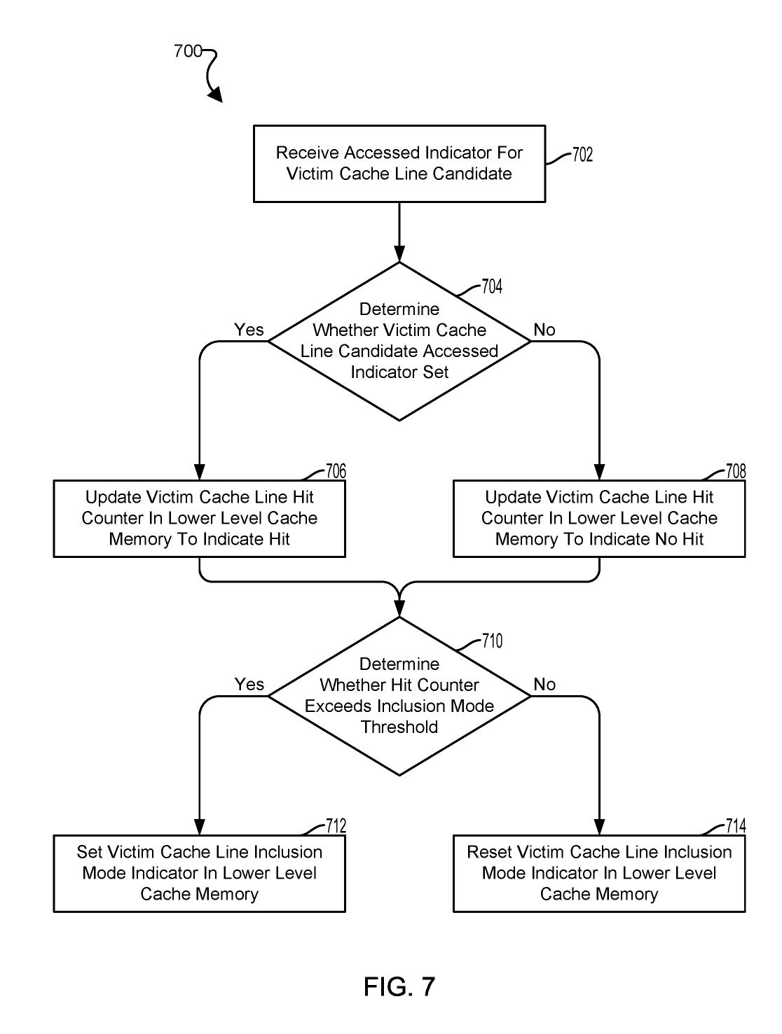

In block 614, the processing device may update the higher level cache memory and the lower level cache memory. Examples of operations that may be involved in updating the lower level cache memory in block 614 in response to determining that the victim cache line candidate dirty indicator is not set (i.e., determination block 606=“No”) are described with reference to the method 700 illustrated in FIG. 7. The processing device may receive the victim cache line candidate from the higher level cache memory. The processing device may receive the victim cache line candidate at any time after determination of the victim cache line candidate, such as while the victim cache line candidate is still stored in the higher level cache memory and/or after eviction of the victim cache line candidate from the higher level cache memory. The received victim cache line candidate may include any combination, including all, of the data stored in the victim cache line candidate, including the tag and state indicators, the accessed indicator, the inclusion mode indicator, the dirty indicator, and/or data and/or instructions for implementing the application executing on the computing device (e.g., computing device 10 in FIG. 1). The processing device may write any combination, including all of, the received data of the victim cache line candidate to the location in the lower level cache memory storing the victim cache line. Examples of operations that may be involved in updating the lower level cache memory in block 614 are described with reference to the method 700 illustrated in FIG. 7.

FIG. 7 illustrates a method 700 for updating a lower level cache memory for reducing clean eviction in a cache memory hierarchy according to an aspect. The method 700 may be implemented in a computing device in software executing in a processor (e.g., the processor 14 in FIGS. 1 and 2), in general purpose hardware, in dedicated hardware (e.g., cache memory manager 250 in FIG. 2), or in a combination of a software-configured processor and dedicated hardware (e.g., processor 14 in FIGS. 1 and 2 and cache memory manager 250 in FIG. 2), such as a processor executing software within a cache memory hierarchy management system (e.g., system configured to promote high locality data to an inclusive mode in FIGS. 3A-3K, system configured to relax exclusivity requirements in FIGS. 9A-9H) that includes other individual components (e.g., memory 16, 24 in FIG. 1, higher level cache memory 300, lower level cache memory 320 in FIGS. 3A-3K and 9A-9H), and various memory/cache controllers. In order to encompass the alternative configurations enabled in various aspects, the hardware implementing the method 700 is referred to herein as a “processing device.” The method 700 includes operations that may be involved in updating the lower level cache memory in block 614 of the method 600 described with reference to FIG. 6.

In block 702, the processing device may receive a signal relating to the victim cache line candidate from the higher level cache memory. The signal may include the accessed indicator for the victim cache line candidate. The processing device may receive the accessed indicator at any time after determination of the victim cache line candidate, such as while the victim cache line candidate is still stored in the higher level cache memory and/or after eviction of the victim cache line candidate from the higher level cache memory.

In determination block 704, the processing device may determine whether the victim cache line candidate accessed indicator is set. As discussed herein, the accessed indicator may have a designated value to indicate that the accessed indicator is set. The processing device may recognize and interpret the value of the accessed indicator to determine whether the accessed indicator is set. For example, as discussed herein, a value of a binary format accessed indicator=“1” may indicate that the dirty indicator is set, and a value of the binary format accessed indicator=“0” may indicate that the dirty indicator is not set, or reset.

As discussed herein, the victim cache line candidate in the higher level cache memory may correspond to a victim cache line in the lower level cache memory. The processing device may be configured to identify the victim cache line in the lower level cache memory that corresponds with the victim cache line candidate.

In response to determining that the victim cache line candidate accessed indicator is set (i.e., determination block 704=“Yes”), the processing device may update the victim cache line hit counter in the lower level cache memory to indicate a hit in block 706. In various aspects, the hit counter may be configured to indicate a number and/or a representation of a number of hits of the cache line in the higher level cache memory corresponding to the victim cache line in the lower level cache memory for any number of tracking periods. A representation of a number may include a representation of a range of numbers. In various aspects, indicating a hit may include changing a value of the hit counter in a manner that indicates at least one more hit of the cache line in the higher level cache memory. The processing device may access the victim cache line in the lower level cache memory and write a value to the hit counter field of the victim cache line to update the hit counter. For example, as discussed herein, a value of a binary hit counter may indicate a number of hits of the cache line in the higher level cache memory, and an increased value of the binary hit counter may indicate a greater number of hits of the cache line in the higher level cache memory. The processing device may use any algorithms and/or operations to update the hit counter of the victim cache line in the lower level cache memory.

In response to determining that the victim cache line candidate accessed indicator is not set (i.e., determination block 704=“Yes”), the processing device may update the victim cache line hit counter in the lower level cache memory to indicate no hit in block 708. In various aspects, determining that the victim cache line candidate accessed indicator is not set may include determining that the victim cache line candidate accessed indicator is reset. In various aspects, indicating no hit, or a miss, may include changing a value of the hit counter in a manner that indicates at least one less hit of the cache line in the higher level cache memory. The processing device may access the victim cache line in the lower level cache memory and write a value to the hit counter field of the victim cache line to update the hit counter. For example, as discussed herein, a value of a binary hit counter may indicate a number of hits of the cache line in the higher level cache memory, and a decreased value of the binary hit counter may indicate a lesser number of hits of the cache line in the higher level cache memory. The processing device may use any algorithms and/or operations to update the hit counter of the victim cache line in the lower level cache memory.

In determination block 710, the processing device may determine whether the hit counter of the victim cache line in the lower level cache memory equals or exceeds an inclusion mode threshold. In various aspects, the inclusion mode threshold may be a value representing a delineation between sets of hit counter values corresponding to an inclusive mode and an exclusive mode of a cache line. The processing device may compare the hit counter of the victim cache line and the inclusion mode threshold to determine a relationship between the hit counter and the inclusion mode threshold, such as whether the hit counter exceeds or does not equal or exceed the inclusion mode threshold.

In response to determining that the hit counter of the victim cache line in the lower level cache memory equals or exceeds the inclusion mode threshold (i.e., determination block 710=“Yes”), the processing device may set the victim cache line inclusion mode indicator in the lower level cache memory in block 712. The processing device may access the victim cache line in the lower level cache memory and write a designated value to the inclusion mode indicator field of the victim cache line to set the inclusion mode indicator. For example, as discussed herein, a value of a binary format inclusion mode indicator=“1” may indicate that the inclusion mode indicator is set. In various aspects, the processing device may determine whether the inclusion mode indicator is already set by accessing the victim cache line and interpreting the value of the inclusion mode indicator to determine whether the inclusion mode indicator is set. In various aspects, the processing device may maintain the inclusion mode indicator in response to determining that the inclusion mode indicator is set. In various aspects, the processing device may set the inclusion mode indicator in response to determining that the inclusion mode indicator is not set, or reset.

In response to determining that the hit counter of the victim cache line in the lower level cache memory does not equal or exceed the inclusion mode threshold (i.e., determination block 710=“No”), the processing device may reset the victim cache line inclusion mode indicator in the lower level cache memory in block 714. The processing device may access the victim cache line in the lower level cache memory and write a designated value to the inclusion mode indicator field of the victim cache line to reset the inclusion mode indicator. For example, as discussed herein, a value of the binary format inclusion mode indicator=“0” may indicate that the inclusion mode indicator is not set, or reset. In various aspects, the processing device may determine whether the inclusion mode indicator is already not set, or reset, by accessing the victim cache line and interpreting the value of the inclusion mode indicator to determine whether the inclusion mode indicator is not set, or reset. The processing device may maintain the inclusion mode indicator in response to determining that the inclusion mode indicator is not set, or reset, and may reset the inclusion mode indicator in response to determining that the inclusion mode indication is set.

FIG. 8 illustrates a method 800 for updating a higher level cache memory for reducing clean eviction in a cache memory hierarchy according to an aspect. The method 800 may be implemented in a computing device in software executing in a processor (e.g., the processor 14 in FIGS. 1 and 2), in general purpose hardware, in dedicated hardware (e.g., cache memory manager 250 in FIG. 2), or in a combination of a software-configured processor and dedicated hardware (e.g., processor 14 in FIGS. 1 and 2 and cache memory manager 250 in FIG. 2), such as a processor executing software within a cache memory hierarchy management system (e.g., system configured to promote high locality data to an inclusive mode in FIGS. 3A-3K, system configured to relax exclusivity requirements in FIGS. 9A-9H) that includes other individual components (e.g., memory 16, 24 in FIG. 1, higher level cache memory 300, lower level cache memory 320 in FIGS. 3A-3K and 9A-9H), and various memory/cache controllers. In order to encompass the alternative configurations enabled in various aspects, the hardware implementing the method 800 is referred to herein as a “processing device.” The method 800 includes operations that may be involved in inserting the retrieved cache line into higher level cache memory in block 416 of the method 400 described with reference to FIG. 4.

In determination block 802, the processing device may determine whether the cache line inclusion mode indicator is set. The processing device may access the cache line in the lower level cache memory and check an inclusion mode indicator field of the cache line for the inclusion mode indicator. The processing device may determine from the inclusion mode indicator whether the inclusion mode indicator is set. For example, as discussed herein, a value of a binary format inclusion mode indicator=“1” may indicate that the inclusion mode indicator is set, and a value of the binary format inclusion mode indicator=“0” may indicate that the inclusion mode indicator is not set, or reset.

In response to determining that the cache line inclusion mode indicator is set (i.e., determination block 802=“Yes”), the processing device may set the cache line inclusion mode indicator in the higher level cache memory in block 804. The processing device may access the cache line in the higher level cache memory and write a designated value to the inclusion mode indicator field of the cache line to set the inclusion mode indicator. For example, as discussed herein, a value of a binary format inclusion mode indicator=“1” may indicate that the inclusion mode indicator is set. In various aspects, the processing device may determine whether the inclusion mode indicator is already set by accessing the cache line in the lower level cache memory and interpreting the value of the inclusion mode indicator to determine whether the inclusion mode indicator is set. In various aspects, the processing device may maintain the inclusion mode indicator in response to determining that the inclusion mode indicator is set.

After setting cache line inclusion mode indicator in the higher level cache memory in block 804 or in response to determining that the cache line inclusion mode indicator is not set (i.e., determination block 802=“No”), the processing device may execute the cache access request for the cache line in the higher level cache memory in block 418 of the method 400 as described with reference to FIG. 4.

FIGS. 9A-9H illustrate examples of reducing clean eviction in a cache memory hierarchy in a system configured to relax exclusivity requirements suitable for implementing various aspects. The examples in FIGS. 9A-9H illustrate various aspects of a cache memory system configured to relax exclusivity requirements, which may include the higher level cache memory 300, the lower level cache memory 320, and any number of cache memory managers (not shown; e.g., cache memory manager 250 in FIG. 2). The higher level cache memory 300 may be any cache memory of a level higher than the lower level cache memory 320, including at least a last level cache memory, which may be a lowest level cache memory of the cache memory hierarchy.

A cache memory manager may be communicatively connected to a processor (e.g., processor 14 in FIGS. 1 and 2) and the higher level cache memory 300 and/or the lower level cache memory 320, and configured to control access to the higher level cache memory 300 and/or the lower level cache memory 320, and to manage and maintain the higher level cache memory 300 and/or the lower level cache memory 320. The cache memory manager may be configured to pass and/or deny memory access requests to the higher level cache memory 300 and/or the lower level cache memory 320 from the processor, pass data and/or instructions to and from the higher level cache memory 300 and/or the lower level cache memory 320, and/or trigger maintenance and/or coherency operations for the higher level cache memory 300 and/or the lower level cache memory 320, including an eviction policy. In various aspects, the higher level cache memory 300 and the lower level cache memory 320 may be associated with different cache memory managers.

FIG. 9A illustrates an example system configured to relax exclusivity requirements with a cache memory hierarchy having the higher level cache memory 300 and the lower level cache memory 320. The higher level cache memory 300 and the lower level cache memory 320 may be divided into any number of segments configured to store data and/or instructions of any size, such as a cache line 902, which may also be referred to as a cache block. The cache line 902 may include data and/or instructions for use by an application executed by a processor and data configured to identify and configure the cache line 902.

In various aspects the cache line 902 may include the filed for tag and state indicators 304, the field for the accessed indicator 306, the field for the inclusion mode indicator 310, and/or the field for the dirty indicator 904. The tag and state indicators 304 may be configured to identify the cache line 902 for access to the cache line 902. The accessed indicator 306 may be configured to indicate whether the cache line 902 is accessed, for example, while in the higher level cache memory 300 between an insertion into the higher level cache memory 300 and an eviction from the higher level cache memory 300, referred to herein as a tracking period. The inclusion mode indicator 310 may be configured to indicate an inclusion mode of the cache line 902. The dirty indicator 904 may be configured to indicate whether data of the cache line is unmodified, referred to as clean data, or modified, referred to as dirty data.

In various aspects, the accessed indicator 306, the inclusion mode indicator 310, and the dirty indicator 904 may be configured using various formats, data, and/or symbols, including any number and/or size. For the sake of example and ease of explanation, not meant to limit the scope of the descriptions and claims: the accessed indicator 306 may be a 1 bit binary indicator for which a “0” value may indicate the cache line 902 is not accessed and a “1” value may indicate the cache line 902 is accessed; the inclusion mode indicator 310 may be a 1 bit binary indicator for which a “0” value may indicate an exclusive mode for the cache line 902 and a “1” value may indicate an inclusive mode for the cache line 902; and the dirty indicator 904 may be a 1 bit binary indicator for which a “0” value may indicate a clean data for the cache line 902 and a “1” value may indicate a dirty data for the cache line 902.

The higher level cache memory 300 and/or the lower level cache memory 320 may be configured as an exclusive cache memory, for which the cache line 902 in removed and/or invalidated in the higher level cache memory 300 and/or the lower level cache memory 320 in response to accesses of the cache line 902 that store the cache line 902 in the other of the higher level cache memory 300 and the lower level cache memory 320.

The cache line 902 may be sent back and forth between the higher level cache memory 300 and the lower level cache memory 320. The cache line 902 sent to either of the higher level cache memory 300 or the lower level cache memory 320 may be written to and stored in the higher level cache memory 300 or the lower level cache memory 320 to which the cache line 902 is sent. In various aspects, the cache line 902 in an exclusive mode (i.e., inclusion mode indicator 310 having a value of “0”) may be removed from or invalidated in the higher level cache memory 300 or the lower level cache memory 320 from which the cache line 902 is sent. In various aspects, the cache line 902 in an inclusive mode (i.e., inclusion mode indicator 310 having a value of “1”) may be maintained in the lower level cache memory 320.

Load and/or store instructions may be used to provide the cache line 902 from another memory (e.g., memory 16, 24 in FIG. 1) to the higher level cache memory 300 and/or the lower level cache memory 320, and/or to send the cache line 902 back and forth between the higher level cache memory 300 and the lower level cache memory 320. An access request for the cache line 902 in the higher level cache memory 300 may result in a miss, and the cache memory controller may be configured to use a load instruction to provide the cache line 902 to the higher level cache memory 300 through the lower level cache memory 320. Also in response to a miss for the cache line 902 in the higher level cache memory 300, the cache memory controller may be configured to use a load instruction to provide the cache line 902 to the higher level cache memory 300.

The cache memory controller may be configured to update and analyze the cache line 902 sent to the higher level cache memory 300 and the lower level cache memory 320 from the other memory, sent between the higher level cache memory 300 and the lower level cache memory 320, and/or in the higher level cache memory 300 and/or the lower level cache memory 320. The type of access instruction for the cache line 902 may prompt the cache memory controller to determine whether to set and/or reset the inclusion mode indicator 310. In various aspects, setting the inclusion mode indicator 310 may include writing a “1” value to the inclusion mode indicator field of the cache line 902 to indicate that the cache line 902 is in an inclusive mode. In various aspects, resetting the inclusion mode indicator 310 may include writing a “0” value to the inclusion mode indicator field of the cache line 902 to indicate that the cache line 902 is in an exclusive mode.

In response to a load instruction for the cache line 902 from the other memory, the cache memory controller may set the inclusion mode indicator 310 for the cache line 902 in the lower level cache memory 320 and in the higher level cache memory 300.

In response to a store instruction for the cache line 902 from the other memory, the cache memory controller may not set, or reset, the inclusion mode indicator 310 for the cache line 902 in the higher level cache memory 300.

In response to a load instruction for the cache line 902 from the higher level cache memory 300 and/or the lower level cache memory 320, the cache memory controller may be maintain the inclusion mode indicator 310 for the cache line 902 from the higher level cache memory 300 and/or the lower level cache memory 320.

In response to a store instruction for the cache line 902 from the higher level cache memory 300 and/or the lower level cache memory 320, the cache memory controller may not set, or reset, the inclusion mode indicator 310 for the cache line 902 in the higher level cache memory 300 and/or the lower level cache memory 320.

In various aspects, when an inclusion mode indicator 310 that is already the value for setting and/or resetting the inclusion mode indicator 310, the cache memory manager may maintain the value of the inclusion mode indicator 310 by setting and/or resetting the inclusion mode indicator 310, and/or by skipping setting and/or resetting the inclusion mode indicator 310.

In response to an access of the cache line 902 in the higher level cache memory 300, the cache memory controller may set the accessed indicator 306 of the cache line 902 in the higher level cache memory 300. In various aspects, setting the accessed indicator 306 may include writing a “1” value to the accessed indicator field of the cache line 902 to indicate that the cache line 902 is accessed.

In response to an eviction of the cache line 902 from the higher level cache memory 300, the cache memory controller may reset the accessed indicator 306 of the cache line 902 in the lower level cache memory 320. In various aspects, resetting the accessed indicator 306 may include writing a “0” value to the accessed indicator field of the cache line 902 to indicate that the cache line 902 is not accessed. The cache memory manager may reset the accessed bit 306 for the cache line 902 sent to the lower level cache memory 320.

In various aspects, when an accessed indicator 306 is already the value for setting and/or resetting the accessed indicator 306, the cache memory manager may maintain the value of the accessed indicator 306 by setting and/or resetting the accessed indicator 306, and/or by skipping setting and/or resetting the accessed indicator 306.

In response to an access of the cache line 902 in the higher level cache memory 300 that modifies the data of the cache line 902, the cache memory controller may set the dirty indicator 904 of the cache line 902 in the higher level cache memory 300. In various aspects, setting the dirty indicator 904 may include writing a “1” value to the dirty indicator field of the cache line 902 to indicate that the data of the cache line 902 is modified.

In response to a store instruction for the cache line 902 from the other memory, the cache memory controller may reset the dirty indicator 904 for the cache line 902 in the higher level cache memory 300. In various aspects, resetting the dirty indicator 904 may include writing a “0” value to the dirty indicator field of the cache line 902 to indicate that the data of the cache line 902 is not modified.

In various aspects, when a dirty indicator 904 is already the value for setting and/or resetting the dirty indicator 904, the cache memory manager may maintain the value of the dirty indicator 904 by setting and/or resetting the dirty indicator 904, and/or by skipping setting and/or resetting the dirty indicator 904.

The cache memory controller may be configured to analyze the accessed indicator 306 and the dirty indicator 904 for the cache line 902 in response to an access of the cache line 902 in the higher level cache memory 300. The cache memory controller may determine that the access of the cache line 902 in the higher level cache memory 300 results in dirty data of the inclusive mode cache line 902, and in response the cache memory controller may not set, or reset, the inclusion mode indicator 310 in the higher level cache memory 300, and send an invalidation message for the cache line 902 in the lower level cache memory 320.

The cache memory controller may be configured to analyze the accessed indicator 306 and the inclusion mode indicator 310 for the cache line 902 in response to an eviction of the cache line 902 from the higher level cache memory 300. The cache memory controller may determine to execute a “silent eviction” in response to determining that the inclusion mode indicator 310 of the cache line 902 in the higher level cache memory 300 is set. In various aspects, a silent eviction may be implemented by removing and/or invalidating the cache line 902 in the higher level cache memory 300 without writing the cache line 902 to the lower level cache memory 320. Silently evicting the cache line 902 from the higher level cache memory 300 avoids executing a clean eviction in which the entire cache line 902 would normally be sent. Thus, silently evicting the cache line 902 may lower power consumed by avoiding repeated cache insertions and may reduce bandwidth usage by silently dropping clean data. Silently evicting or dropping the clean data may be accomplished by removal and/or invalidation of the date of the cache line 902 in the higher level cache memory 300 without sending the clean data to the lower level cache memory 320. The cache memory controller may further determine to send a demote message for the inclusive mode cache line 902 in the lower level cache memory 320 configured to prompt resetting the inclusion mode indicator 310 of the cache line 902 in the lower level cache memory 320.

In response to determining that the inclusion mode indicator 310 of the cache line 902 in the higher level cache memory 300 is not set, or reset, the cache memory controller may evict the cache line 902 from the higher level cache memory 300 and determine whether the evicted cache line 902 is accessed by analyzing the accessed indicator 306. In response to determining that the accessed indicator 306 of the evicted cache line 902 is set, the cache memory controller may set the inclusion mode indicator 310 for the cache line 902 in the lower level cache memory 320. In response to determining that the accessed indicator 306 of the evicted cache line 902 is not set, or reset, the cache memory controller may not set, or reset, the inclusion mode indicator 310 for the cache line 902 in the lower level cache memory 320.

The descriptions of the higher level cache memory 300, the lower level cache memory 320, the cache line 902, the accessed indicator 306, the inclusion mode indicator 310, and the dirty indicator 904 apply to like numbered elements illustrated in FIGS. 9B-9H.

FIG. 9B illustrates the example system configured to relax exclusivity requirements with a cache memory hierarchy in which a cache line (A) 902a from another memory may be written to the higher level cache memory 300 and to the lower level cache memory 320, and a cache line (B) 902b from the other memory may be written the higher level cache memory 300. The cache line 902a may be written from the other memory to the higher level cache memory 300 and to the lower level cache memory 320 in response to a load instruction for the cache line 902a. The cache line 902b may be written from the other memory to the higher level cache memory 300 in response to a store instruction for the cache line 902b. In the example illustrated in FIG. 9B, as a result of the load instruction, the cache line 902a written to the higher level cache memory 300 and to the lower level cache memory 320 may include the not set, or reset, dirty indicator 904, the not set, or reset, accessed indicator 306, and the set inclusion mode indicator 310. The cache line 902b written to the higher level cache memory 300 may include the set dirty indicator 904, the not set, or reset, accessed indicator 306, and the not set, or reset, inclusion mode indicator 310.

FIG. 9C illustrates the example system configured to relax exclusivity requirements with a cache memory hierarchy in which the cache lines 902a, 902b may be evicted from the higher level cache memory 300. The cache lines 902a, 902b in the higher level cache memory 300 prior to access of the cache lines 902a, 902b in the higher level cache memory 300 may be the same as the cache lines 902a, 902b in the higher level cache memory 300 as described for the example illustrated in FIG. 9B.

The cache lines 902a, 902b in the higher level cache memory 300 may be accessed during a tracking period prompting the cache memory manager to set the accessed indicator 306. The access to the cache line cache line 902a in the higher level cache 300 may be an access that does not modify the data of the cache line 902a. Such an access may result in the dirty indicator 904 indicating that the data of the cache line 902a in the higher level cache memory 300 is clean.

In the example illustrated in FIG. 9C, the cache line 902a in the higher level cache memory 300 may include the not set, or reset, dirty indicator 904, the set accessed indicator 306, and the set inclusion mode indicator 310 indicating that the cache line 902a is in the inclusive mode. Based on analysis of the set accessed indicator 306 and the set inclusion mode indicator 310, the cache line 902a may be silently evicted from the higher level cache memory 300, removing and/or invalidating the inclusive mode cache line 902a in the higher level cache memory 300 without sending the cache line 902a to the lower level cache 320. The cache line 902a may already be stored in the lower level cache 320 and may be the same as the cache line 902a in the lower level cache memory 320 as described for the example illustrated in FIG. 9B.

The access to the cache line cache line 902b in the higher level cache 300 may be an access that modifies the data of the cache line 902b. Such an access may result in the dirty indicator 904 indicating that the data of the cache line 902b in the higher level cache memory 300 is dirty. In the example illustrated in FIG. 9C, the cache line 902b in the higher level cache memory 300 may include the set dirty indicator 904, the set accessed indicator 306, and the not set, or reset, inclusion mode indicator 310 indicating that the cache line 902b is in the exclusive mode. Based on analysis of the set accessed indicator 306 and the not set, or reset, inclusion mode indicator 310, the cache line 902b may be evicted from the higher level cache memory 300, removing and/or invalidating the inclusive mode cache line 902b in the higher level cache memory 300, sending the cache line 902b to the lower level cache 320. In response to the set accessed indicator 306 and the not set, or reset, inclusion mode indicator 310, the cache memory manager may set the inclusion mode indicator 310 of the cache line 902b in the lower level cache memory 320. The cache memory manager may reset the accessed indicator 306.

FIG. 9D illustrates the example system configured to relax exclusivity requirements with a cache memory hierarchy in which the cache lines 902a, 902b may be written to the higher level cache memory 300 from the lower level cache memory 320. The cache line 902a in the lower level cache memory 320 at the time of sending the cache line 902a to the higher level cache memory 300 may be the same as the cache line 902a in the lower level cache memory 320 as described for the example illustrated in FIG. 9C.

In the example illustrated in FIG. 9D, the cache line 902a in the lower level cache memory 320 may include the not set, or reset, dirty indicator 904, the not set, or reset, accessed indicator 306, and the set inclusion mode indicator 310 indicating that the cache line 902a is in the inclusive mode. The cache line 902a may be written to the higher level cache memory 300 from the lower level cache memory 320 in response to a load instruction for the cache line 902a. The cache memory manager may analyze the inclusion mode indicator 310 of the cache line 902a and maintain the set inclusion mode indicator 310 of the cache line 902a in the higher level cache memory 300. The cache line 902b may be written to the higher level cache memory 300 from the lower level cache memory 320 in response to a store instruction for the cache line 902b. The cache line 902b in the lower level cache memory 320 may initially be the same as the cache line 902b in the lower level cache memory 320 as described for the example illustrated in FIG. 9C.

In response to the store instruction for the cache line 902b, the cache memory manager may not set, or reset, the inclusion mode indicator 310 indicating that the cache line 902b is in the exclusive mode. In the example illustrated in FIG. 9B, as a result of the store instruction, the cache line 902b in the lower level cache memory 320 may include the set dirty indicator 904, the not set, or reset, accessed indicator 306, and the not set, or reset, inclusion mode indicator 310. The cache line 902b in the lower level cache memory 320 may be written to the higher level cache memory 300 and may include the set dirty indicator 904, the not set, or reset, accessed indicator 306, and the not set, or reset, inclusion mode indicator 310. The cache memory manager may analyze the inclusion mode indicator 310 of the cache line 902b and maintain the not set, or reset, inclusion mode indicator 310 of the cache line 902b in the higher level cache memory 300. The exclusive mode cache line 902b may be removed and/or invalidated in the lower level cache memory 320.

FIG. 9E illustrates the example system configured to relax exclusivity requirements with a cache memory hierarchy in which the cache lines 902a, 902b may be evicted from the higher level cache memory 300. The cache line 902a in the higher level cache memory 300 may be the same as the cache line 902a in the higher level cache memory 300 as described for the example illustrated in FIG. 9D.

The cache line 902a in the higher level cache memory 300 may not be accessed during a tracking period, and no change may be made to the not set, or reset, accessed indicator 306. In the example illustrated in FIG. 9E, the cache line 902a in the higher level cache memory 300 may include the not set, or reset, dirty indicator 904, the not set, or reset, accessed indicator 306, and the set inclusion mode indicator 310 indicating that the cache line 902a is in the inclusive mode. Based on analysis of the not set, or reset, accessed indicator 306 and the set inclusion mode indicator 310, the cache line 902a may be silently evicted from the higher level cache memory 300, removing and/or invalidating the inclusive mode cache line 902a in the higher level cache memory 300 without sending the cache line 902a to the lower level cache 320. The cache line 902a may already be stored in the lower level cache 320 and initially may be the same as the cache line 902a in the lower level cache memory 320 as described for the example illustrated in FIG. 9D.

Further based on the analysis of the not set, or reset, accessed indicator 306 and the set inclusion mode indicator 310, a demote message may be sent to prompt the cache memory manager to update the cache line 902a in the lower level cache memory 320 by demoting the cache line 902a from inclusive mode to exclusive mode by resetting the inclusion mode indicator 310. The cache line 902b in the higher level cache memory 300 prior to access of the cache line 902b in the higher level cache memory 300 may be the same as the cache line 902b in the higher level cache memory 300 as described for the example illustrated in FIG. 9D.

The cache line 902b in the higher level cache memory 300 may be accessed during a tracking period prompting the cache memory manager to set the accessed indicator 306. The access to the cache line cache line 902b in the higher level cache 300 may be an access that modifies the data of the cache line 902b. Such an access may result in the dirty indicator 904 indicating that the data of the cache line 902b in the higher level cache memory 300 is dirty.

In the example illustrated in FIG. 9E, the cache line 902b in the higher level cache memory 300 may include the set dirty indicator 904, the set accessed indicator 306, and the not set, or reset, inclusion mode indicator 310 indicating that the cache line 902b is in the exclusive mode. Based on analysis of the set accessed indicator 306 and the not set, or reset, inclusion mode indicator 310, the cache line 902b may be evicted from the higher level cache memory 300, removing and/or invalidating the exclusive mode cache line 902b in the higher level cache memory 300, sending the cache line 902b to the lower level cache 320. In response to the set accessed indicator 306 and the not set, or reset, inclusion mode indicator 310, the cache memory manager may set the inclusion mode indicator 310 of the cache line 902b in the lower level cache memory 320. The cache memory manager may reset the accessed indicator 306.

FIG. 9F illustrates the example system configured to relax exclusivity requirements with a cache memory hierarchy in which the cache lines 902a, 902b may be written to the higher level cache memory 300 from the lower level cache memory 320. The cache line 902a in the lower level cache memory 320 at the time of sending the cache line 902a to the higher level cache memory 300 may be the same as the cache line 902a in the lower level cache memory 320 as described for the example illustrated in FIG. 9E.

In the example illustrated in FIG. 9F, the cache line 902a in the lower level cache memory 320 may include the not set, or reset, dirty indicator 904, the not set, or reset, accessed indicator 306, and the not set, or reset, inclusion mode indicator 310 indicating that the cache line 902a is in the exclusive mode. The cache line 902a may be written to the higher level cache memory 300 from the lower level cache memory 320 in response to a load instruction for the cache line 902a. The cache memory manager may analyze the inclusion mode indicator 310 of the cache line 902a and maintain the not set, or reset, inclusion mode indicator 310 of the cache line 902a in the higher level cache memory 300. The exclusive mode cache line 902a may be removed and/or invalidated in the lower level cache memory 320. The cache line 902b may be written to the higher level cache memory 300 from the lower level cache memory 320 in response to a load instruction for the cache line 902b. The cache line 902b in the lower level cache memory 320 at the time of sending the cache line 902b to the higher level cache memory 300 may be the same as the cache line 902b in the lower level cache memory 320 as described for the example illustrated in FIG. 9E.

In the example illustrated in FIG. 9F, the cache line 902b in the lower level cache memory 320 may include the set dirty indicator 904, the not set, or reset, accessed indicator 306, and the set inclusion mode indicator 310 indicating that the cache line 902b is in the inclusive mode. The cache line 902b may be written to the higher level cache memory 300 from the lower level cache memory 320 in response to a load instruction for the cache line 902b. The cache memory manager may analyze the inclusion mode indicator 310 of the cache line 902b and maintain the set inclusion mode indicator 310 of the cache line 902b in the higher level cache memory 300. The cache memory manager may reset the dirty indicator 904

FIG. 9G illustrates the example system configured to relax exclusivity requirements with a cache memory hierarchy in which the cache line 902b may be accessed in the higher level cache memory 300 prompting sending of an invalidation message for the cache line 902b in the lower level cache memory 320. The cache line 902b in the higher level cache memory 300 prior to access of the cache line 902b in the higher level cache memory 300 may be the same as the cache line 902b in the higher level cache memory 300 as described for the example illustrated in FIG. 9F.

The cache line 902b in the higher level cache memory 300 may be accessed during a tracking period prompting the cache memory manager to set the accessed indicator 306. The access to the cache line cache line 902b may be by a store instruction for the cache line 902b in the higher level cache 300, which may modify the data of the cache line 902b. Such an access may result in the dirty indicator 904 indicating that the data of the cache line 902b in the higher level cache memory 300 is dirty. Based on analysis of the set dirty indicator 904 and the set inclusion mode indicator 310, the cache line 902b may be updated by resetting the inclusion mode indicator 310 of cache line 902b in the higher level cache memory 300. In the example illustrated in FIG. 9G, the cache line 902b in the higher level cache memory 300 may include the set dirty indicator 904, the set accessed indicator 306, and the not set, or reset, inclusion mode indicator 310 indicating that the cache line 902b is in the exclusive mode. Also based on the analysis of the set dirty indicator 904 and the set inclusion mode indicator 310, an invalidation message may be sent prompting the cache memory manager to remove and/or invalidate the cache line 902b in the lower level cache 320.

FIG. 9H illustrates the example system configured to relax exclusivity requirements with a cache memory hierarchy in which the cache lines 902a, 902b may be evicted from the higher level cache memory 300. The cache line 902a in the higher level cache memory 300 may be the same as the cache line 902a in the higher level cache memory 300 as described for the example illustrated in FIG. 9F.

The cache line 902a in the higher level cache memory 300 may not be accessed during a tracking period, and no change may be made to the not set, or reset, accessed indicator 306. In the example illustrated in FIG. 9H, the cache line 902a in the higher level cache memory 300 may include the not set, or reset, dirty indicator 904, the not set, or reset, accessed indicator 306, and the not set, or reset, inclusion mode indicator 310 indicating that the cache line 902a is in the exclusive mode. Based on analysis of the not set, or reset, accessed indicator 306 and the not set, or reset, inclusion mode indicator 310, the cache line 902a may be evicted from the higher level cache memory 300, removing and/or invalidating the exclusive mode cache line 902a in the higher level cache memory 300. The cache line 902a may be written to the lower level cache 320. Further from the analysis of the not set, or reset, inclusion mode indicator 310, the not set, or reset, inclusion mode indicator 310 may be maintained or reset. The cache line 902b in the higher level cache memory 300 prior to access of the cache line 902b in the higher level cache memory 300 may be the same as the cache line 902b in the higher level cache memory 300 as described for the example illustrated in FIG. 9G. The cache line 902b in the higher level cache memory 300 may already be accessed as indicated by the set the accessed indicator 306.

The access to the cache line cache line 902b in the higher level cache 300 may be an access that modifies the data of the cache line 902b as indicated by the set dirty indicator 904. In the example illustrated in FIG. 9H, the cache line 902b in the higher level cache memory 300 may include the set dirty indicator 904, the set accessed indicator 306, and the not set, or reset, inclusion mode indicator 310 indicating that the cache line 902b is in the exclusive mode. Based on analysis of the set accessed indicator 306 and the not set, or reset, inclusion mode indicator 310, the cache line 902b may be evicted from the higher level cache memory 300, removing and/or invalidating the exclusive mode cache line 902b in the higher level cache memory 300, sending the cache line 902b to the lower level cache 320. In response to the set accessed indicator 306 and the not set, or reset, inclusion mode indicator 310, the cache memory manager may set the inclusion mode indicator 310 of the cache line 902b in the lower level cache memory 320. The cache memory manager may reset the accessed indicator 306.

FIG. 10 illustrates a method 1000 for retrieving a cache line from a lower level cache memory for reducing clean eviction in a cache memory hierarchy according to an aspect. The method 1000 may be implemented in a computing device in software executing in a processor (e.g., the processor 14 in FIGS. 1 and 2), in general purpose hardware, in dedicated hardware (e.g., cache memory manager 250 in FIG. 2), or in a combination of a software-configured processor and dedicated hardware (e.g., processor 14 in FIGS. 1 and 2 and cache memory manager 250 in FIG. 2), such as a processor executing software within a cache memory hierarchy management system (e.g., system configured to promote high locality data to an inclusive mode in FIGS. 3A-3K, system configured to relax exclusivity requirements in FIGS. 9A-9H) that includes other individual components (e.g., memory 16, 24 in FIG. 1, higher level cache memory 300, lower level cache memory 320 in FIGS. 3A-3K and 9A-9H), and various memory/cache controllers. In order to encompass the alternative configurations enabled in various aspects, the hardware implementing the method 1000 is referred to herein as a “processing device.” The method 1000 includes operations that may be involved in retrieving the cache line from a lower level cache memory in block 410 of the method 400 described with reference to FIG. 4.

In block 502, the processing device may receive a cache access request for the cache line in the lower level cache memory. The cache access request may include a read, write, load, and/or store cache access request.

In determination block 1002, the processing device may determine whether cache access request results in a hit for the targeted cache line of the cache access request in the lower level cache memory. In various aspects, the processing device may check directly in the lower level cache memory and/or check a snoop directory of the lower level cache memory to determine whether the targeted cache line is stored in the lower level cache memory. Determining from the check that the targeted cache line is stored in the lower level cache memory may indicate that the cache access request results in a hit for the targeted cache line in the lower level cache memory. Determining from the check that the targeted cache line is not stored in the lower level cache memory may indicate that the cache access request results in a miss for the targeted cache line in the lower level cache memory.

In response to determining that the cache access request results in a hit for the targeted cache line of the cache access request in the lower level cache memory (i.e., determination block 1002=“Yes”), the processing device may return the cache line to the higher level cache memory in block 504.

In determination block 1004, the processing device may determine whether the cache line inclusion mode indicator is set. The processing device may access the cache line in the lower level cache memory and check an inclusion mode indicator field of the cache line for the inclusion mode indicator. The processing device may determine from the inclusion mode indicator whether the inclusion mode indicator is set. For example, as discussed herein, a value of a binary format inclusion mode indicator=“1” may indicate that the inclusion mode indicator is set, and a value of the binary format inclusion mode indicator =“0” may indicate that the inclusion mode indicator is not set, or reset.

In response to determining that the cache line inclusion mode indicator is set (i.e., determination block 1004=“Yes”), the processing device may determine whether the cache access request for the target cache line in the higher level cache memory is a load instruction in determination block 1006. The cache access request may include an instruction indicator configured to identify a type of instruction for the cache access request, including identifying a read instruction, a write instruction, a load instruction, and/or a store instruction.

In response to determining that the cache access request for the target cache line in the higher level cache memory is a load instruction (i.e., determination block 1006=“Yes”), the processing device may maintain the cache line in the lower level cache memory in block 508. Maintaining the cache line in the lower level cache memory may include keeping a copy of the cache line returned to the higher level cache memory in the lower level cache memory. To keep the copy of the cache line in the lower level cache memory, the processing device may not evict, remove, and/or invalidate the cache line from the lower level cache memory.

In response to determining that the cache line inclusion mode indicator is not set (i.e., determination block 1004=“No”) or in response to determining that the cache access request for the target cache line in the higher level cache memory is not a load instruction (i.e., determination block 1006=“No”), the processing device may invalidate the cache line in the lower level cache memory in block 510. The processing device may invalidate the cache line returned to the higher level cache memory by marking the cache line invalid in the lower level cache memory. In various aspects, the processing device may remove and/or evict the cache line from the lower level cache memory.

In response to determining that the cache access request does not result in a hit for the targeted cache line of the cache access request in the lower level cache memory (i.e., determination block 1002=“No”), the processing device may retrieve the cache line from another memory (e.g., memory 16, 24 in FIG. 1) in block 1008.

In determination block 1010, the processing device may determine whether the cache access request for the target cache line in the higher level cache memory is a load instruction. As discussed herein, the cache access request may include an instruction indicator configured to identify a type of instruction for the cache access request, including identifying a read instruction, a write instruction, a load instruction, and/or a store instruction.

In response to determining that the cache access request for the target cache line in the higher level cache memory is a load instruction (i.e., determination block 1010=“Yes”), the processing device may return the cache line to the lower level cache memory and set the inclusion mode indicator in block 1012. The processing device may insert the cache line into the lower level cache memory. In various aspects, the cache line may be returned first from the other memory to the lower level cache memory and then from the lower level cache memory to higher level cache memory, and/or directly from the other memory to the higher level cache memory. To set the cache line inclusion mode indicator in the lower level cache memory, the processing device may access the cache line in the lower level cache memory and write a designated value to the inclusion mode indicator field of the cache line. For example, as discussed herein, a value of a binary format inclusion mode indicator=“1” may indicate that the inclusion mode indicator is set. In various aspects, the processing device may determine whether the inclusion mode indicator is already set by accessing the cache line in the lower level cache memory and interpreting the value of the inclusion mode indicator to determine whether the inclusion mode indicator is set. In various aspects, the processing device may maintain the inclusion mode indicator in response to determining that the inclusion mode indicator is set.

In response to determining that the cache access request for the target cache line in the higher level cache memory is not a load instruction (i.e., determination block 1010=“No”), the processing device may determine whether a free location is available in the higher level cache memory in determination block 412 of the method 400 described with reference to FIG. 4.

FIG. 11 illustrates a method 1100 for finding a victim cache line candidate in a higher level cache memory for reducing clean eviction in a cache memory hierarchy according to an aspect. The method 1100 may be implemented in a computing device in software executing in a processor (e.g., the processor 14 in FIGS. 1 and 2), in general purpose hardware, in dedicated hardware (e.g., cache memory manager 250 in FIG. 2), or in a combination of a software-configured processor and dedicated hardware (e.g., processor 14 in FIGS. 1 and 2 and cache memory manager 250 in FIG. 2), such as a processor executing software within a cache memory hierarchy management system (e.g., system configured to promote high locality data to an inclusive mode in FIGS. 3A-3K, system configured to relax exclusivity requirements in FIGS. 9A-9H) that includes other individual components (e.g., memory 16, 24 in FIG. 1, higher level cache memory 300, lower level cache memory 320 in FIGS. 3A-3K and 9A-9H), and various memory/cache controllers. In order to encompass the alternative configurations enabled in various aspects, the hardware implementing the method 1100 is referred to herein as a “processing device.” The method 1100 includes operations that may be involved in retrieving the cache line from a lower level cache memory in block 414 of the method 400 described with reference to FIG. 4.

In block 602, the processing device may determine the victim cache line candidate in the higher level cache memory. In various aspects, the processing device may use any eviction criteria, such as least recently used, not most recently used, first in first out, etc., to determine the victim cache line candidate.

In determination block 1102, the processing device may determine whether the victim cache line candidate inclusion mode indicator is set. The processing device may access the victim cache line candidate in the higher level cache memory and check an inclusion mode indicator field of the victim cache line candidate for the inclusion mode indicator. The processing device may determine from the inclusion mode indicator whether the inclusion mode indicator is set. For example, as discussed herein, a value of a binary format inclusion mode indicator=“1” may indicate that the inclusion mode indicator is set, and a value of the binary format inclusion mode indicator=“0” may indicate that the inclusion mode indicator is not set, or reset.

In response to determining that the victim cache line candidate inclusion mode indicator is set (i.e., determination block 1102=“Yes”), the processing device may determine whether the victim cache line candidate accessed indicator is set in determination block 1104. As discussed herein, the accessed indicator may have a designated value to indicate that the accessed indicator is set. The processing device may recognize and interpret the value of the accessed indicator to determine whether the accessed indicator is set. For example, as discussed herein, a value of a binary format accessed indicator=“1” may indicate that the dirty indicator is set, and a value of the binary format accessed indicator=“0” may indicate that the dirty indicator is not set, or reset.

In response to determining that the victim cache line candidate accessed indicator is not set (i.e., determination block 1104=“No”), the processing device may send a signal relating to the victim cache line candidate from the higher level cache memory to the lower level cache memory in block 1106. The signal may be a demote message for the victim cache line candidate. The demote message may be configured to prompt demoting the victim cache line candidate from inclusive mode to exclusive mode in the lower level cache by resetting the inclusion mode indicator for the victim cache line candidate, as described further herein with reference to the method 1300 in FIG. 13. The demote message may include the victim cache line candidate accessed indicator.

After sending a signal relating to the victim cache line candidate from the higher level cache memory to the lower level cache memory in block 1106 or in response to determining that the victim cache line candidate accessed indicator is set (i.e., determination block 1104=“Yes”), the processing device may silently evict the victim cache line candidate from the higher level cache memory In block 1108. Silently evicting the victim cache line candidate may be implemented by removing and/or invalidating the victim cache line candidate in the higher level cache memory without writing the victim cache line candidate to the lower level cache memory.

In response to determining that the victim cache line candidate accessed indicator is set (i.e., determination block 1104=“Yes”), the processing device may silently evict the victim cache line candidate from the higher level cache memory in block 1108 and update the lower level cache memory in block 1110.

In response to determining that the victim cache line candidate inclusion mode indicator is not set (i.e., determination block 1102=“No”), the processing device may send the victim cache line candidate to the lower level cache memory in block 610. The processing device may access the victim cache line candidate in the higher level cache memory and retrieve any combination, including all, of data stored in the victim cache line candidate, including the tag and state indicators, the accessed indicator, the inclusion mode indicator, the dirty indicator, and/or data and/or instructions for implementing the application executing on the computing device (e.g., computing device 10 in FIG. 1). The processing device may send the victim cache line candidate to the lower level cache memory for use in updating the victim cache line in the lower level cache memory.

In block 612, the processing device may evict the victim cache line candidate from the higher level cache memory. In various aspects, the processing device may evict the victim cache line candidate by marking the victim cache line candidate invalid in the higher level cache memory, by removing the victim cache line candidate from the higher level cache memory, and/or overwriting the victim cache line candidate in the higher level cache memory.

In block 1110 the processing device may update the lower level cache memory. In various aspects, updating the lower level cache memory may be implemented by the processing device maintaining the victim cache line in the lower level cache memory. Maintaining the victim cache line in the lower level cache memory may include keeping a copy of the victim cache line candidate of the higher level cache memory in the lower level cache memory. To keep the copy of the victim cache line candidate in the lower level cache memory, the processing device may not evict, remove, and/or invalidate the cache line from the lower level cache memory.

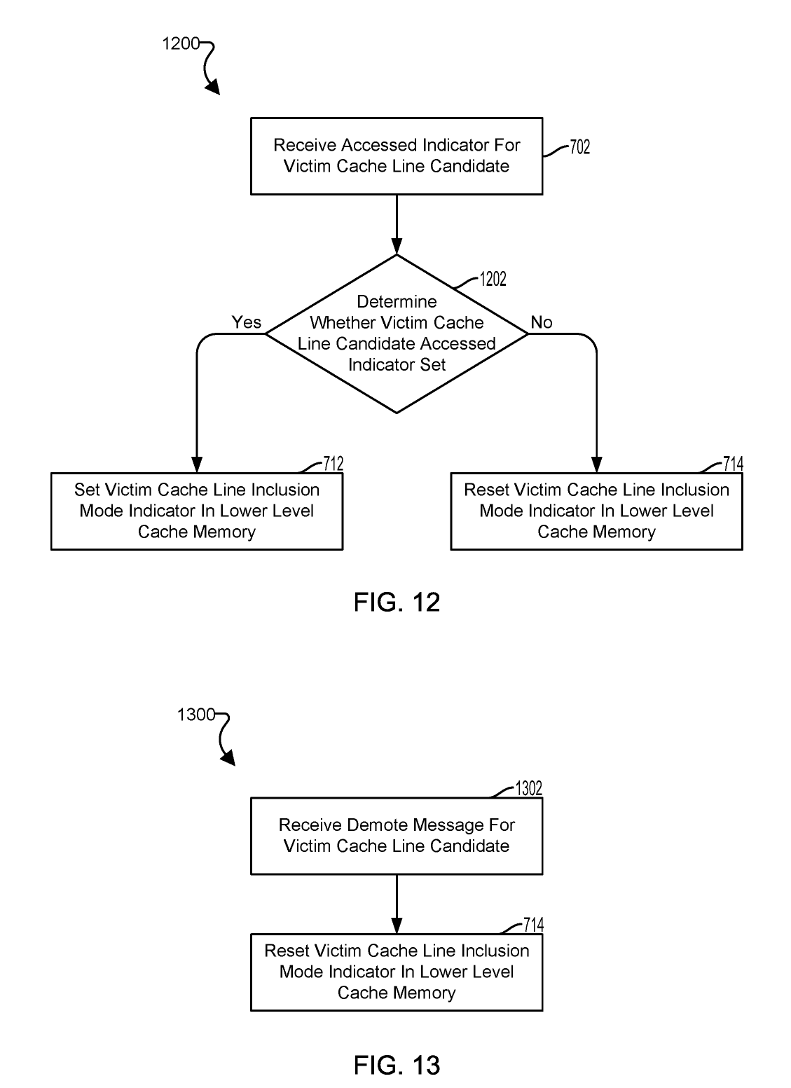

The operations performed in block 1110 may depend upon determinations made in determination blocks 1102 and 1104. For example, updating the lower level cache memory in block 1100, in response to determining that the victim cache line candidate accessed indicator is not set (i.e., determination block 1104=“No”), such as described with reference to the method 1300 illustrated in FIG. 13. As another example, in response to determining that the victim cache line candidate inclusion mode indicator is not set (i.e., determination block 1102=“No”), updating the lower level cache memory may include updating the victim cache line in the lower level cache memory, such as described with reference to the method 1200 illustrated in FIG. 12. The processing device may receive the victim cache line candidate from the higher level cache memory. The processing device may receive the victim cache line candidate at any time after determination of the victim cache line candidate, such as while the victim cache line candidate is still stored in the higher level cache memory and/or after eviction of the victim cache line candidate from the higher level cache memory. The received victim cache line candidate may include any combination, including all, of the data stored in the victim cache line candidate, including the tag and state indicators, the accessed indicator, the inclusion mode indicator, the dirty indicator, and/or data and/or instructions for implementing the application executing on the computing device (e.g., computing device 10 in FIG. 1). The processing device may write any combination, including all of, the received data of the victim cache line candidate to the location in the lower level cache memory storing the victim cache line.

FIG. 12 illustrates a method 1200 for updating a lower level cache memory for reducing clean eviction in a cache memory hierarchy according to an aspect. The method 1200 may be implemented in a computing device in software executing in a processor (e.g., the processor 14 in FIGS. 1 and 2), in general purpose hardware, in dedicated hardware (e.g., cache memory manager 250 in FIG. 2), or in a combination of a software-configured processor and dedicated hardware (e.g., processor 14 in FIGS. 1 and 2 and cache memory manager 250 in FIG. 2), such as a processor executing software within a cache memory hierarchy management system (e.g., system configured to promote high locality data to an inclusive mode in FIGS. 3A-3K, system configured to relax exclusivity requirements in FIGS. 9A-9H) that includes other individual components (e.g., memory 16, 24 in FIG. 1, higher level cache memory 300, lower level cache memory 320 in FIGS. 3A-3K and 9A-9H), and various memory/cache controllers. In order to encompass the alternative configurations enabled in various aspects, the hardware implementing the method 1200 is referred to herein as a “processing device.” The method 1200 includes operations that may be involved in updating the lower level cache memory in block 1110 of the method 1100 described with reference to FIG. 11.

In block 702, the processing device may receive a signal relating to the victim cache line candidate from the higher level cache memory. The signal may include the accessed indicator for the victim cache line candidate. The processing device may receive the accessed indicator at any time after determination of the victim cache line candidate, such as while the victim cache line candidate is still stored in the higher level cache memory and/or after eviction of the victim cache line candidate from the higher level cache memory.

In determination block 1202, the processing device may determine whether the victim cache line candidate accessed indicator is set. As discussed herein, the accessed indicator may have a designated value to indicate that the accessed indicator is set. The processing device may recognize and interpret the value of the accessed indicator to determine whether the accessed indicator is set. For example, as discussed herein, a value of a binary format accessed indicator=“1” may indicate that the dirty indicator is set, and a value of the binary format accessed indicator=“0” may indicate that the dirty indicator is not set, or reset.

As discussed herein, the victim cache line candidate in the higher level cache memory may correspond to a victim cache line in the lower level cache memory. The processing device may be configured to identify the victim cache line in the lower level cache memory that corresponds with the victim cache line candidate.

In response to determining that the victim cache line candidate accessed indicator is set (i.e., determination block 1202=“Yes”), the processing device may set the victim cache line inclusion mode indicator in the lower level cache memory in block 712. The processing device may access the victim cache line in the lower level cache memory and write a designated value to the inclusion mode indicator field of the victim cache line to set the inclusion mode indicator. For example, as discussed herein, a value of a binary format inclusion mode indicator =“1” may indicate that the inclusion mode indicator is set. In various aspects, the processing device may determine whether the inclusion mode indicator is already set by accessing the victim cache line and interpreting the value of the inclusion mode indicator to determine whether the inclusion mode indicator is set. In various aspects, the processing device may maintain the inclusion mode indicator in response to determining that the inclusion mode indicator is set. In various aspects, the processing device may set the inclusion mode indicator in response to determining that the inclusion mode indicator is not set, or reset.

In response to determining that the victim cache line candidate accessed indicator is not set (i.e., determination block 1202=“No”), the processing device may reset the victim cache line inclusion mode indicator in the lower level cache memory in block 714. The processing device may access the victim cache line in the lower level cache memory and write a designated value to the inclusion mode indicator field of the victim cache line to reset the inclusion mode indicator. For example, as discussed herein, a value of the binary format inclusion mode indicator=“0” may indicate that the inclusion mode indicator is not set, or reset. In various aspects, the processing device may determine whether the inclusion mode indicator is already not set, or reset, by accessing the victim cache line and interpreting the value of the inclusion mode indicator to determine whether the inclusion mode indicator is not set, or reset. The processing device may maintain the inclusion mode indicator in response to determining that the inclusion mode indicator is not set, or reset, and may reset the inclusion mode indicator in response to determining that the inclusion mode indication is set.

FIG. 13 illustrates a method 1300 for updating a lower level cache memory for reducing clean eviction in a cache memory hierarchy according to an aspect. The method 1300 may be implemented in a computing device in software executing in a processor (e.g., the processor 14 in FIGS. 1 and 2), in general purpose hardware, in dedicated hardware (e.g., cache memory manager 250 in FIG. 2), or in a combination of a software-configured processor and dedicated hardware (e.g., processor 14 in FIGS. 1 and 2 and cache memory manager 250 in FIG. 2), such as a processor executing software within a cache memory hierarchy management system (e.g., system configured to promote high locality data to an inclusive mode in FIGS. 3A-3K, system configured to relax exclusivity requirements in FIGS. 9A-9H) that includes other individual components (e.g., memory 16, 24 in FIG. 1, higher level cache memory 300, lower level cache memory 320 in FIGS. 3A-3K and 9A-9H), and various memory/cache controllers. In order to encompass the alternative configurations enabled in various aspects, the hardware implementing the method 1300 is referred to herein as a “processing device.” The method 1300 includes operations that may be involved in updating the lower level cache memory in block 1110 of the method 1100 described with reference to FIG. 11.

In block 1302, the processing device may receive signal relating to the victim cache line candidate. As discussed herein, the signal may be the demote message for the victim cache line candidate. The demote message may be sent in block 1106 of the method 1100 as described with reference to FIG. 11. The demote message may include the victim cache line candidate accessed indicator. As discussed herein, the victim cache line candidate in the higher level cache memory may correspond to a victim cache line in the lower level cache memory. The processing device may be configured to identify the victim cache line in the lower level cache memory that corresponds with the victim cache line candidate for which the demote message is sent.

In block 714, the processing device may reset the victim cache line inclusion mode indicator in the lower level cache memory as described for the like number block of the method 700 with reference to FIG. 7. The victim cache line for which the inclusion mode indicator may be reset may correspond to the victim cache line candidate for which the demote message is sent. The processing device may demote the victim cache line from an inclusive mode to an exclusive mode in response to the demote message by resetting the victim cache line inclusion mode indicator. In various aspects, the victim cache line candidate accessed indicator of the demote message may prompt the processing device may to reset the victim cache line inclusion mode indicator in the lower level cache memory. The processing device may access the victim cache line in the lower level cache memory and write a designated value to the inclusion mode indicator field of the victim cache line to reset the inclusion mode indicator. For example, as discussed herein, a value of the binary format inclusion mode indicator=“0” may indicate that the inclusion mode indicator is not set, or reset. In various aspects, the processing device may determine whether the inclusion mode indicator is already not set, or reset, by accessing the victim cache line and interpreting the value of the inclusion mode indicator to determine whether the inclusion mode indicator is not set, or reset. The processing device may maintain the inclusion mode indicator in response to determining that the inclusion mode indicator is not set, or reset, and may reset the inclusion mode indicator in response to determining that the inclusion mode indication is set.

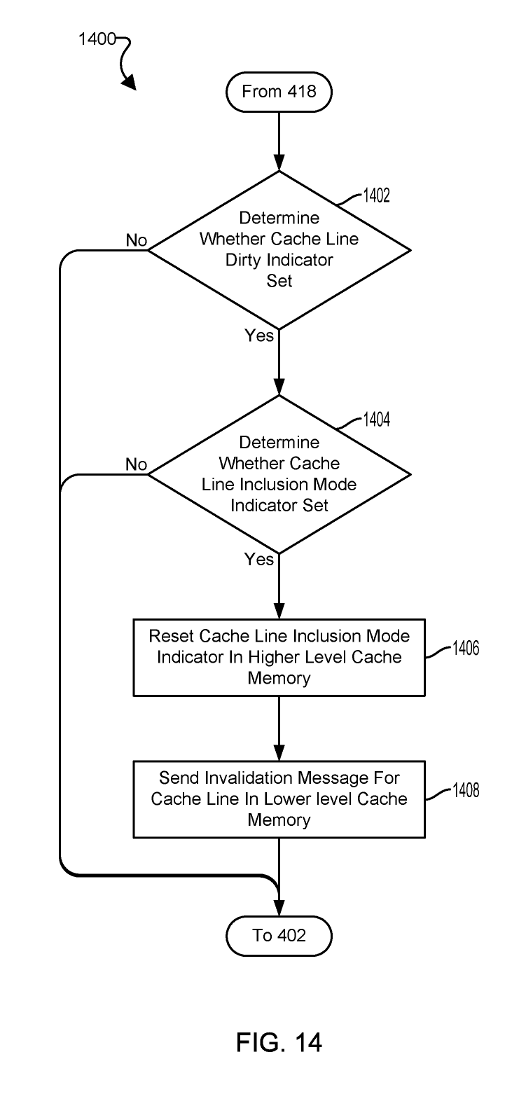

FIG. 14 illustrates a method 1400 for reducing clean eviction in a cache memory hierarchy according to an aspect. The method 1400 may be implemented in a computing device in software executing in a processor (e.g., the processor 14 in FIGS. 1 and 2), in general purpose hardware, in dedicated hardware (e.g., cache memory manager 250 in FIG. 2), or in a combination of a software-configured processor and dedicated hardware (e.g., processor 14 in FIGS. 1 and 2 and cache memory manager 250 in FIG. 2), such as a processor executing software within a cache memory hierarchy management system (e.g., system configured to promote high locality data to an inclusive mode in FIGS. 3A-3K, system configured to relax exclusivity requirements in FIGS. 9A-9H) that includes other individual components (e.g., memory 16, 24 in FIG. 1, higher level cache memory 300, lower level cache memory 320 in FIGS. 3A-3K and 9A-9H), and various memory/cache controllers. In order to encompass the alternative configurations enabled in various aspects, the hardware implementing the method 1400 is referred to herein as a “processing device.”

In various aspects, the method 1400 may expand upon the method 400 described with reference to FIG. 4. For example, the method 1400 may begin following the processing device executing the cache access request for the cache line in the higher level cache memory in block 418 of the method 400.

In determination block 1402, the processing device may determine whether the cache line dirty indicator is set. The processing device may access the cache line in the higher level cache memory and check a dirty indicator field of the cache line for the dirty indicator. The processing device may determine from the dirty indicator whether the dirty indicator is set. For example, as discussed herein, a value of a binary format dirty indicator=“1” may indicate that the dirty indicator is set, and a value of the binary format dirty indicator =“0” may indicate that the dirty indicator is not set, or reset.

In response to determining that the cache line dirty indicator is set (i.e., determination block 1402=“Yes”), the processing device may determine whether the cache line inclusion mode indicator is set in determination block 1404. The processing device may access the cache line in the higher level cache memory and check an inclusion mode indicator field of the cache line for the inclusion mode indicator. The processing device may determine from the inclusion mode indicator whether the inclusion mode indicator is set. For example, as discussed herein, a value of a binary format inclusion mode indicator =“1” may indicate that the inclusion mode indicator is set, and a value of the binary format inclusion mode indicator=“0” may indicate that the inclusion mode indicator is not set, or reset.

In response to determining that the cache line inclusion mode indicator is set (i.e., determination block 1404=“Yes”), the processing device may reset the cache line inclusion mode indicator in the higher level cache memory in block 1406. The processing device may access the cache line in the higher level cache memory and write a designated value to the inclusion mode indicator field of the cache line to reset the inclusion mode indicator. For example, as discussed herein, a value of the binary format inclusion mode indicator=“0” may indicate that the inclusion mode indicator is not set, or reset. In various aspects, the processing device may determine whether the inclusion mode indicator is already not set, or reset, by accessing the cache line and interpreting the value of the inclusion mode indicator to determine whether the inclusion mode indicator is not set, or reset. The processing device may maintain the inclusion mode indicator in response to determining that the inclusion mode indicator is not set, or reset, and may reset the inclusion mode indicator in response to determining that the inclusion mode indication is set.

In block 1408, the processing device may send an invalidation message for the cache line in lower level cache memory. The cache line inclusion mode indicator in the higher level cache memory being reset in block 1406 may change the cache line to an exclusive mode from an inclusive mode. In the inclusive mode the cache line may be maintained in the higher and lower level cache memories. In the exclusive mode, the cache line may be maintained in one of the higher level cache memory or the lower level cache memory. Changing the cache line to the exclusive mode from the inclusive mode may result in invalidating and/or removing the cache line from one of the higher level cache memory or the lower level cache memory. The cache line in the higher level cache memory may be subject to execution before eviction from the higher level cache memory. Invalidating and/or removing the cache line from the higher level cache memory before eviction from the higher level cache memory may result in extra cache accesses to the lower level cache memory to retrieve the cache line for the execution. As such, invalidating and/or removing the cache line from the lower level cache memory may reduce a number of cache accesses by eliminating the extra cache access to retrieve the cache line from the lower level memory for the execution before eviction from the higher level cache memory.

After sending the invalidation message in block 1408, or in response to determining that the cache line dirty indicator is not set (i.e., determination block 1402=“No”), or in response to determining that the cache line inclusion mode indicator is not set (i.e., determination block 1404=“No”), the processing device may receive a cache access request for a cache line in a higher level cache memory in block 402 restarting the method 400 as described with reference to FIG. 4.

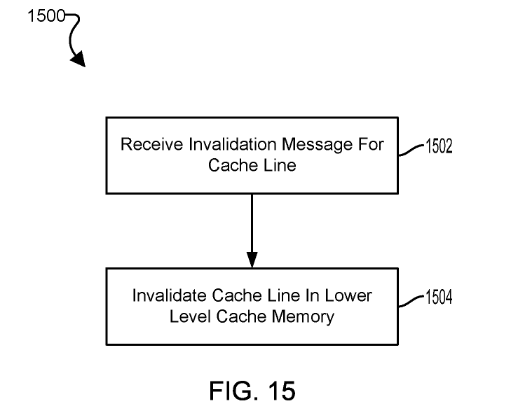

FIG. 15 illustrates a method 1500 for updating a lower level cache memory for reducing clean eviction in a cache memory hierarchy according to an aspect. The method 1500 may be implemented in a computing device in software executing in a processor (e.g., the processor 14 in FIGS. 1 and 2), in general purpose hardware, in dedicated hardware (e.g., cache memory manager 250 in FIG. 2), or in a combination of a software-configured processor and dedicated hardware (e.g., processor 14 in FIGS. 1 and 2 and cache memory manager 250 in FIG. 2), such as a processor executing software within a cache memory hierarchy management system (e.g., system configured to promote high locality data to an inclusive mode in FIGS. 3A-3K, system configured to relax exclusivity requirements in FIGS. 9A-9H) that includes other individual components (e.g., memory 16, 24 in FIG. 1, higher level cache memory 300, lower level cache memory 320 in FIGS. 3A-3K and 9A-9H), and various memory/cache controllers. In order to encompass the alternative configurations enabled in various aspects, the hardware implementing the method 1500 is referred to herein as a “processing device.”

In block 1502, the processing device may receive the invalidation message for the cache line in lower level cache memory. The invalidation message may contain an identifier for the cache line in the lower level cache memory and an instruction to invalidate and/or remove the cache line from the lower level cache memory.

In block 1504, the processing device may invalidate and/or remove the cache line from the lower level cache memory. In various aspects, the processing device may mark the cache line as invalid in the lower level cache memory. In various aspects, the processing device may remove the cache line from the lower level cache memory, such as by deenergizing portions of the lower level cache memory storing the cache line and/or by overwriting the cache line in the lower level cache memory.

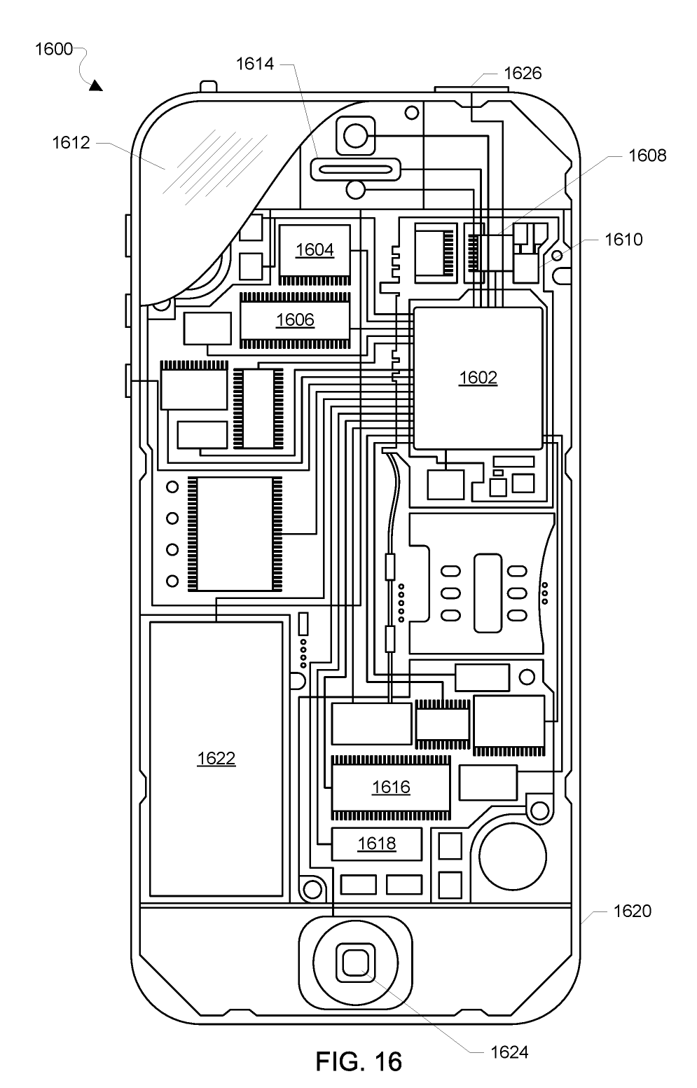

The various aspects (including, but not limited to, aspects described above with reference to FIGS. 1-15) may be implemented in a wide variety of computing systems including mobile computing devices, an example of which suitable for use with the various aspects is illustrated in FIG. 16. The mobile computing device 1600 may include a processor 1602 coupled to a touchscreen controller 1604 and an internal memory 1606. The processor 1602 may be one or more multicore integrated circuits designated for general or specific processing tasks. The internal memory 1606 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1604 and the processor 1602 may also be coupled to a touchscreen panel 1612, such as a resistive-sensing touchscreen, capacitive-sensing touchscreen, infrared sensing touchscreen, etc. Additionally, the display of the computing device 1600 need not have touch screen capability.

The mobile computing device 1600 may have one or more radio signal transceivers 1608 (e.g., Peanut, Bluetooth, ZigBee, Wi-Fi, RF radio) and antennae 1610, for sending and receiving communications, coupled to each other and/or to the processor 1602. The transceivers 1608 and antennae 1610 may be used with the above-mentioned circuitry to implement the various wireless transmission protocol stacks and interfaces. The mobile computing device 1600 may include a cellular network wireless modem chip 1616 that enables communication via a cellular network and is coupled to the processor.

The mobile computing device 1600 may include a peripheral device connection interface 1618 coupled to the processor 1602. The peripheral device connection interface 1618 may be singularly configured to accept one type of connection, or may be configured to accept various types of physical and communication connections, common or proprietary, such as Universal Serial Bus (USB), FireWire, Thunderbolt, or PCIe. The peripheral device connection interface 1618 may also be coupled to a similarly configured peripheral device connection port (not shown).

The mobile computing device 1600 may also include speakers 1614 for providing audio outputs. The mobile computing device 1600 may also include a housing 1620, constructed of a plastic, metal, or a combination of materials, for containing all or some of the components described herein. The mobile computing device 1600 may include a power source 1622 coupled to the processor 1602, such as a disposable or rechargeable battery. The rechargeable battery may also be coupled to the peripheral device connection port to receive a charging current from a source external to the mobile computing device 1600. The mobile computing device 1600 may also include a physical button 1624 for receiving user inputs. The mobile computing device 1600 may also include a power button 1626 for turning the mobile computing device 1600 on and off.

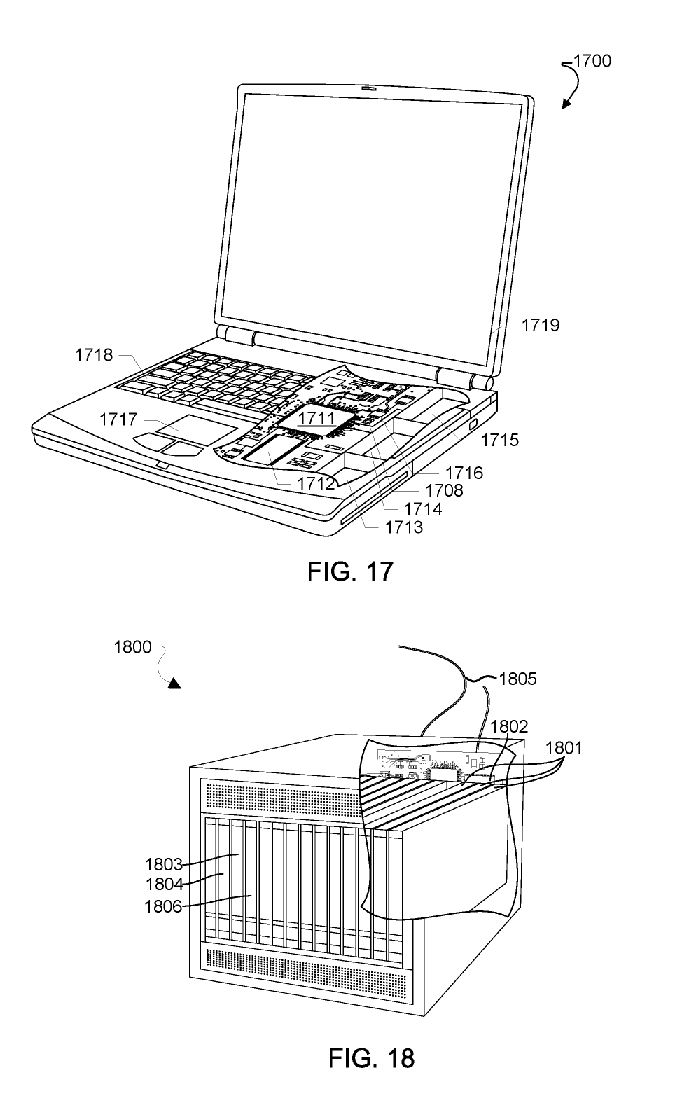

The various aspects (including, but not limited to, aspects described above with reference to FIGS. 1-15) may be implemented in a wide variety of computing systems include a laptop computer 1700 an example of which is illustrated in FIG. 17. Many laptop computers include a touchpad touch surface 1717 that serves as the computer's pointing device, and thus may receive drag, scroll, and flick gestures similar to those implemented on computing devices equipped with a touch screen display and described above. A laptop computer 1700 will typically include a processor 1711 coupled to volatile memory 1712 and a large capacity nonvolatile memory, such as a disk drive 1713 of Flash memory. Additionally, the computer 1700 may have one or more antenna 1708 for sending and receiving electromagnetic radiation that may be connected to a wireless data link and/or cellular telephone transceiver 1716 coupled to the processor 1711. The computer 1700 may also include a floppy disc drive 1714 and a compact disc (CD) drive 1715 coupled to the processor 1711. In a notebook configuration, the computer housing includes the touchpad 1717, the keyboard 1718, and the display 1719 all coupled to the processor 1711. Other configurations of the computing device may include a computer mouse or trackball coupled to the processor (e.g., via a USB input) as are well known, which may also be used in conjunction with the various aspects.

The various aspects (including, but not limited to, aspects described above with reference to FIGS. 1-15) may also be implemented in fixed computing systems, such as any of a variety of commercially available servers. An example server 1800 is illustrated in FIG. 18. Such a server 1800 typically includes one or more multicore processor assemblies 1801 coupled to volatile memory 1802 and a large capacity nonvolatile memory, such as a disk drive 1804. As illustrated in FIG. 18, multicore processor assemblies 1801 may be added to the server 1800 by inserting them into the racks of the assembly. The server 1800 may also include a floppy disc drive, compact disc (CD) or digital versatile disc (DVD) disc drive 1806 coupled to the processor 1801. The server 1800 may also include network access ports 1803 coupled to the multicore processor assemblies 1801 for establishing network interface connections with a network 1805, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various aspects may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects and implementations without departing from the scope of the claims. Thus, the present disclosure is not intended to be limited to the aspects and implementations described herein, but is to be accorded the widest scope consistent with the following claims and the principles and novel features disclosed herein.

What is claimed is:

1. A method of reducing clean evictions in an exclusive cache memory hierarchy on a computing device, comprising:
receiving an accessed indicator of a victim cache line candidate in a higher level cache memory;
updating a hit counter of a victim cache line in a lower level cache memory that corresponds to the victim cache line candidate in response to receiving the accessed indicator of the victim cache line candidate;
determining whether the hit counter of the victim cache line exceeds an inclusion mode threshold;
setting an inclusion mode indicator of the victim cache line in response to determining that the hit counter of the victim cache line exceeds the inclusion mode threshold; and
resetting the inclusion mode indicator of the victim cache line in response to determining that the hit counter of the victim cache line does not exceed the inclusion mode threshold.

2. The method of claim 1, further comprising determining whether the accessed indicator of the victim cache line candidate is set, wherein updating a hit counter of a victim cache line comprises:
increasing the hit counter of the victim cache line in response to determining that the accessed indicator of the victim cache line candidate is set; and
decreasing the hit counter of the victim cache line in response to determining that the accessed indicator of the victim cache line candidate is not set.

3. The method of claim 1, further comprising:
determining the victim cache line candidate in higher level cache memory;
determining whether an inclusion mode indicator of the victim cache line candidate is set;
determining whether a dirty indicator of the victim cache line candidate is set in response to determining that the inclusion mode indicator of the victim cache line candidate is set; and
sending the accessed indicator of the victim cache line candidate to the lower level cache memory in response to determining that the dirty indicator of the victim cache line candidate is not set.

4. The method of claim 3, further comprising:
evicting the victim cache line candidate from the higher level cache memory in response to determining that the dirty indicator of the victim cache line candidate is set;
sending all data of the victim cache line candidate to the lower level cache memory in response to determining that the dirty indicator of the victim cache line candidate is set;
evicting the victim cache line candidate from the higher level cache memory in response to determining that the inclusion mode indicator of the victim cache line candidate is not set; and
sending all the data of the victim cache line candidate to the lower level cache memory in response to determining that the inclusion mode indicator of the victim cache line candidate is not set.

5. The method of claim 1, further comprising:
receiving a first cache access request for a cache line in the higher level cache memory;
determining whether the first cache access request is a hit for the cache line; and
sending a second cache access request for the cache line to the lower level cache memory in response to determining that the first cache access request is not a hit for the cache line.

6. The method of claim 5, further comprising:
receiving the second cache access request for the lower level cache memory;
returning the cache line from the lower level cache memory to the higher level cache memory;
determining whether an inclusion mode indicator of the cache line in the lower level cache memory is set;
maintaining the cache line in the lower level cache memory in response to determining that the inclusion mode indicator of the cache line in the lower level cache memory is set; and
invalidating the cache line in the lower level cache memory in response to determining that the inclusion mode indicator of the cache line in the lower level cache memory is not set.

7. The method of claim 6, further comprising:
inserting the returned cache line into the higher level cache memory;
setting an inclusion mode indicator of the returned cache line in response to determining that the inclusion mode indicator of the cache line in the lower level cache memory is set; and
executing the first cache access request.

8. The method of claim 5, further comprising:
determining whether an accessed indicator of the cache line is set in response to determining that the first cache access request is a hit for the cache line;
setting the accessed indicator of the cache line in response to determining that the accessed indicator of the cache line is not set; and
executing the first cache access request.

9. A computing device, comprising:
a processor;
a higher level cache memory;
a lower level cache memory; and
a cache memory manager communicatively connected to the processor, the higher level cache memory, and the lower level cache memory, and configured to perform operations comprising:
receiving an accessed indicator of a victim cache line candidate in the higher level cache memory;
updating a hit counter of a victim cache line in the lower level cache memory that corresponds to the victim cache line candidate in response to receiving the accessed indicator of the victim cache line candidate;
determining whether the hit counter of the victim cache line exceeds an inclusion mode threshold;
setting an inclusion mode indicator of the victim cache line in response to determining that the hit counter of the victim cache line exceeds the inclusion mode threshold; and
resetting the inclusion mode indicator of the victim cache line in response to determining that the hit counter of the victim cache line does not exceed the inclusion mode threshold.

10. The computing device of claim 9, wherein the cache memory manager is configured to perform operations further comprising determining whether the accessed indicator of the victim cache line candidate is set, wherein updating a hit counter of a victim cache line comprises:
increasing the hit counter of the victim cache line in response to determining that the accessed indicator of the victim cache line candidate is set; and
decreasing the hit counter of the victim cache line in response to determining that the accessed indicator of the victim cache line candidate is not set.

11. The computing device of claim 9, wherein the cache memory manager is configured to perform operations further comprising:
determining the victim cache line candidate in higher level cache memory;
determining whether an inclusion mode indicator of the victim cache line candidate is set;
determining whether a dirty indicator of the victim cache line candidate is set in response to determining that the inclusion mode indicator of the victim cache line candidate is set; and
sending the accessed indicator of the victim cache line candidate to the lower level cache memory in response to determining that the dirty indicator of the victim cache line candidate is not set.

12. The computing device of claim 11, wherein the cache memory manager is configured to perform operations further comprising:
evicting the victim cache line candidate from the higher level cache memory in response to determining that the dirty indicator of the victim cache line candidate is set;
sending all data of the victim cache line candidate to the lower level cache memory in response to determining that the dirty indicator of the victim cache line candidate is set;
evicting the victim cache line candidate from the higher level cache memory in response to determining that the inclusion mode indicator of the victim cache line candidate is not set; and
sending all the data of the victim cache line candidate to the lower level cache memory in response to determining that the inclusion mode indicator of the victim cache line candidate is not set.

13. The computing device of claim 9, wherein the cache memory manager is configured to perform operations further comprising:
receiving a first cache access request for a cache line in the higher level cache memory;
determining whether the first cache access request is a hit for the cache line;
sending a second cache access request for the cache line to the lower level cache memory in response to determining that the first cache access request is not a hit for the cache line;
determining whether an accessed indicator of the cache line is set in response to determining that the first cache access request is a hit for the cache line; and
setting the accessed indicator of the cache line in response to determining that the accessed indicator of the cache line is not set.

14. The computing device of claim 13, wherein the cache memory manager is configured to perform operations further comprising:
receiving the second cache access request for the lower level cache memory;
returning the cache line from the lower level cache memory to the higher level cache memory;
determining whether an inclusion mode indicator of the cache line in the lower level cache memory is set;
maintaining the cache line in the lower level cache memory in response to determining that the inclusion mode indicator of the cache line in the lower level cache memory is set; and
invalidating the cache line in the lower level cache memory in response to determining that the inclusion mode indicator of the cache line in the lower level cache memory is not set.

15. The computing device of claim 14, wherein the cache memory manager is configured to perform operations further comprising:
inserting the returned cache line into the higher level cache memory;
setting an inclusion mode indicator of the returned cache line in response to determining that the inclusion mode indicator of the cache line in the lower level cache memory is set; and
executing the first cache access request.

16. A method of reducing clean evictions in an exclusive cache memory hierarchy on a computing device, comprising:
receiving a signal relating to a victim cache line candidate in a higher level cache memory; and
updating an inclusion mode indicator of a victim cache line in a lower level cache memory that corresponds to the victim cache line candidate in response to receiving the signal relating to the victim cache line candidate.

17. The method of claim 16, wherein the signal relating to the victim cache line candidate comprises an accessed indicator of the victim cache line candidate,
the method further comprising determining whether the accessed indicator of the victim cache line candidate is set,
wherein updating an inclusion mode indicator of a victim cache line comprises:
setting the inclusion mode indicator of the victim cache line in response to determining that the accessed indicator of the victim cache line candidate is set; and
resetting the inclusion mode indicator of the victim cache line in response to determining that the accessed indicator of the victim cache line candidate is not set.

18. The method of claim 16, wherein:
the signal relating to the victim cache line candidate comprises a demote message from the higher level cache memory; and
updating an inclusion mode indicator of a victim cache line comprises resetting the inclusion mode indicator of the victim cache line in response to receiving the demote message.

19. The method of claim 16, further comprising
determining the victim cache line candidate in higher level cache memory;
determining whether an inclusion mode indicator of the victim cache line candidate is set;
silently evicting the victim cache line candidate in response to determining that the inclusion mode indicator of the victim cache line candidate is set;
determining whether an accessed indicator of the victim cache line candidate is set in response to determining that the inclusion mode indicator of the victim cache line candidate is set; and
sending a demote message to the lower level cache memory in response to determining that the accessed indicator of the victim cache line candidate is not set.

20. The method of claim 16, further comprising:
receiving a first cache access request for a cache line in the higher level cache memory;
determining whether the first cache access request is a hit for the cache line; and
sending a second cache access request for the cache line to the lower level cache memory in response to determining that the first cache access request is not a hit for the cache line.

21. The method of claim 20, further comprising:
receiving the second cache access request for the lower level cache memory;
determining whether the second cache access request is a hit for the cache line;
returning the cache line from the lower level cache memory to the higher level cache memory in response to determining that the second cache access request is a hit for the cache line;
determining whether an inclusion mode indicator of the cache line in the lower level cache memory is set;
invalidating the cache line in the lower level cache memory in response to determining that the inclusion mode indicator of the cache line in the lower level cache memory is not set;
determining whether the first cache access request includes a load instruction in response to determining that the inclusion mode indicator of the cache line in the lower level cache memory is set;
maintaining the cache line in the lower level cache memory in response to determining that the first cache access request includes a load instruction; and
invalidating the cache line in the lower level cache memory in response to determining that the first cache access request does not include a load instruction.

22. The method of claim 20, further comprising:
receiving the second cache access request for the lower level cache memory;
determining whether the second cache access request is a hit for the cache line;
retrieving the cache line from a memory in response to determining that the second cache access request is not a hit for the cache line;
determining whether the first cache access request includes a load instruction;
inserting the cache line into the lower level cache memory in response to the first cache access request includes a load instruction;
setting an inclusion mode indicator for the cache line in the lower level cache memory; and
returning the cache line to the higher level cache memory.

23. The method of claim 16, further comprising:
receiving a first cache access request for a cache line in the higher level cache memory;
executing the first cache access request;
determining whether a dirty indicator for the cache line is set;
determining whether an inclusion mode indicator for the cache line is set in response to determining that the dirty indicator for the cache line is set;
resetting the inclusion mode indicator for the cache line in response to determining that the inclusion mode indicator for the cache line is set; and
sending an invalidation message for the cache line to the lower level cache memory in response to determining that the inclusion mode indicator for the cache line is set.

24. A computing device, comprising:
a processor;
a higher level cache memory;
a lower level cache memory; and
a cache memory manager communicatively connected to the processor, the higher level cache memory, and the lower level cache memory, and configured to perform operations comprising:
receiving a signal relating to a victim cache line candidate in the higher level cache memory; and
updating an inclusion mode indicator of a victim cache line in the lower level cache memory that corresponds to the victim cache line candidate in response to receiving the signal relating to the victim cache line candidate.

25. The computing device of claim 24, wherein:
the signal relating to the victim cache line candidate comprises an accessed indicator of the victim cache line candidate;
the cache memory manager is configured to perform operations further comprising determining whether the accessed indicator of the victim cache line candidate is set; and
the cache memory manager is configured to perform operations such that updating an inclusion mode indicator of a victim cache line comprises:
setting the inclusion mode indicator of the victim cache line in response to determining that the accessed indicator of the victim cache line candidate is set; and
resetting the inclusion mode indicator of the victim cache line in response to determining that the accessed indicator of the victim cache line candidate is not set.

26. The computing device of claim 24, wherein:
the signal relating to the victim cache line candidate comprises a demote message from the higher level cache memory, and
the cache memory manager is configured to perform operations such that updating an inclusion mode indicator of a victim cache line comprises resetting the inclusion mode indicator of the victim cache line in response to receiving the demote message.

27. The computing device of claim 24, wherein the cache memory manager is configured to perform operations further comprising:
determining the victim cache line candidate in higher level cache memory;
determining whether an inclusion mode indicator of the victim cache line candidate is set;
silently evicting the victim cache line candidate in response to determining that the inclusion mode indicator of the victim cache line candidate is set;
determining whether an accessed indicator of the victim cache line candidate is set in response to determining that the inclusion mode indicator of the victim cache line candidate is set; and
sending a demote message to the lower level cache memory in response to determining that the accessed indicator of the victim cache line candidate is not set.

28. The computing device of claim 24, wherein the cache memory manager is configured to perform operations further comprising:
receiving a first cache access request for a cache line in the higher level cache memory;
determining whether the first cache access request is a hit for the cache line;
sending a second cache access request for the cache line to the lower level cache memory in response to determining that the first cache access request is not a hit for the cache line;
receiving the second cache access request for the lower level cache memory;
determining whether the second cache access request is a hit for the cache line;
returning the cache line from the lower level cache memory to the higher level cache memory in response to determining that the second cache access request is a hit for the cache line;
determining whether an inclusion mode indicator of the cache line in the lower level cache memory is set;
invalidating the cache line in the lower level cache memory in response to determining that the inclusion mode indicator of the cache line in the lower level cache memory is not set;
determining whether the first cache access request includes a load instruction in response to determining that the inclusion mode indicator of the cache line in the lower level cache memory is set;
maintaining the cache line in the lower level cache memory in response to determining that the first cache access request includes a load instruction; and
invalidating the cache line in the lower level cache memory in response to determining that the first cache access request does not include a load instruction.

29. The computing device of claim 24, wherein the cache memory manager is configured to perform operations further comprising:
receiving a first cache access request for a cache line in the higher level cache memory;
determining whether the first cache access request is a hit for the cache line;
sending a second cache access request for the cache line to the lower level cache memory in response to determining that the first cache access request is not a hit for the cache line;
receiving the second cache access request for the lower level cache memory;
determining whether the second cache access request is a hit for the cache line;
retrieving the cache line from a memory in response to determining that the second cache access request is not a hit for the cache line;
determining whether the first cache access request includes a load instruction;
inserting the cache line into the lower level cache memory in response to the first cache access request includes a load instruction;
setting an inclusion mode indicator for the cache line in the lower level cache memory; and
returning the cache line to the higher level cache memory.

30. The computing device of claim 24, wherein the cache memory manager is configured to perform operations further comprising:
receiving a first cache access request for a cache line in the higher level cache memory;
executing the first cache access request;
determining whether a dirty indicator for the cache line is set;
determining whether an inclusion mode indicator for the cache line is set in response to determining that the dirty indicator for the cache line is set;
resetting the inclusion mode indicator for the cache line in response to determining that the inclusion mode indicator for the cache line is set; and
sending an invalidation message for the cache line to the lower level cache memory in response to determining that the inclusion mode indicator for the cache line is set.
